(19) United States
(12) Patent Application Publication
(10) Pub. No.: US 2021/0389924 A1
(43) Pub. Date: Dec. 16, 2021

(54) Extracting and Redacting Sensitive Information from Audio

(71) Applicant: AT&T Intellectual Property I, L.P., Atlanta, GA (US)

(72) Inventors: Shiu Chong, Fair Haven, NJ (US); Michael Kamlet, Chicago, IL (US); Michael Petys, Lawrenceville, GA (US); Timothy Smith, Lawrenceville, GA (US); Andreea Cuculeanu, Red Bank, NJ (US); Kathleen Flynn, Freehold, NJ (US); John Tadlock, Sunnyvale, TX (US); Kenneth Williams, Manasquan, NJ (US); Steven Brakke, Cumming, GA (US); Michael Silva, Milford, NJ (US); Keith Gouveia, Heath, TX (US)

(73) Assignee: AT&T Intellectual Property I, L.P., Atlanta, GA (US)

(21) Appl. No.: 16/897,389

(22) Filed: Jun. 10, 2020

(51) Int. Cl. G06F 3/16; G10L 15/22; G10L 15/30; H04W 12/02; H04M 3/42

(52) U.S. Cl. CPC G06F 3/165; G06F 3/167; G10L 15/22; G10L 2015/223; H04W 12/02; H04M 3/42221; G10L 15/30

(57) ABSTRACT

Concepts and technologies are disclosed herein for extracting and redacting sensitive information from audio. A call having audio and being associated with a customer can be received at a computing device, and the call can be routed to an agent device. During the call, the computing device can detect an impending disclosure of sensitive personal information of the customer. The computing device can generate, during the call, sensitive data that can correspond to the sensitive personal information. The sensitive data can be generated based on sensitive audio of the call. The computing device can provide modified audio to the agent device in real-time or non-real-time. The modified audio can include nonsensitive audio of the call and can omit the sensitive audio. The sensitive data can be provided to a call handling application that is in communication with the computing device and with the agent device.

### BACKGROUND

When interacting with service providers for communications services, customers may provide (automatically or on request) sensitive personal information such as credit card numbers, account numbers, social security numbers, birthdates, combinations thereof, or the like. Because of the ever-increasing frequency with which sensitive personal information is stolen and/or otherwise misappropriated, the common exchange of such information may increase the odds of misuse of such sensitive personal information.

For example, various criminal elements have been known to misappropriate sensitive personal information for various purposes such as identity theft, sale through various channels, etc. Various entities have been fined for the loss of such information (e.g., the Federal Communications Commission (“FCC”) has imposed fines on companies that have mistakenly allowed the misappropriation of such sensitive personal information). Some states, meanwhile, have enacted laws or regulations mandating that agents should never see or hear a customer's sensitive personal information, notwithstanding that these agents typically are tasked with collecting that information.

To address these and other considerations, some companies rely on interactive voice response (“IVR”) systems, or the like, to collect sensitive personal information from customers during a call. For example, an agent may transfer a call to an IVR for obtaining the sensitive personal information, and the IVR may return the call to the agent after the sensitive personal information has been obtained. Such approaches are disruptive to the call and can negatively impact the customer service experience of these customers.

### SUMMARY

The present disclosure is directed to extracting and redacting sensitive information from audio. The extraction and redaction illustrated and described herein can occur in real-time, near real-time, and/or non-real-time. A call can be received at a call center, a phone system, or a component of a call center or phone system such as, for example a communication gateway. In some embodiments, the communication gateway can be configured to remove identifying information associated with the call (e.g., data identifying a customer device used to connect to the call center, data identifying a customer associated with the customer device, a phone number associated with the customer, combinations thereof, or the like) from the call and/or data associated with the call, though this is not necessarily the case. The communication gateway can be configured in some embodiments to assign a call identifier to the call. The call identifier can be used instead of, or in a combination with, the identifying information. The communication gateway or other infrastructure of the call center or other phone system can connect the call to a device such as, for example, a computing device that can execute or host a speech recognition engine and an extraction and redaction engine.

An agent that is to handle the call can be identified and the call can be connected to the agent device associated with the agent. Although the call has been routed to the agent device, embodiments of the concepts and technologies disclosed herein enable the computing device to analyze audio associated with the call, to detect an impending exchange of sensitive personal information, to modify audio associated with the call before passing a modified version of the audio to the agent device, and to generate sensitive data that represents the sensitive personal information. In particular, the speech recognition engine can perform speech recognition on the audio associated with the call during the entirety of the call and/or at particular times during the call. Output from the speech recognition engine can be provided to the extraction and redaction engine. The extraction and redaction engine can be configured to determine, based on output from the speech recognition engine (e.g., text associated with the call, etc.), that sensitive personal information is about to be disclosed during the call. In some embodiments of the concepts and technologies disclosed herein, the determination that sensitive personal information is about to be disclosed can occur in real-time.

The extraction and redaction engine can remove, from audio associated with the call, the sensitive audio that corresponds to the sensitive personal information, and provide modified audio to the agent device as part of the modified call. The modified audio can include substitute audio and/or otherwise may omit the sensitive audio. The extraction and redaction engine can generate sensitive data that represents the sensitive personal information and provide the sensitive data to the call handling application. An agent application executed by an agent device handling the call can be configured to generate nonsensitive data that represents nonsensitive information and provide the nonsensitive data to the call handling application. In some embodiments of the concepts and technologies disclosed herein, the removal of the sensitive audio, the providing of the modified call, and the generation of the sensitive data and nonsensitive data can all occur in real-time.

The call handling application can generate call data and provide the call data to one or more backend systems for implementation (e.g., to pay a bill, to create an order, to provision services, etc.). The extraction and redaction engine also can include functionality for generating reports, and can provide the reports to one or more recipients. In some embodiments, the agent can have the ability to bypass or deactivate the functionality of the extraction and redaction engine, for example by generating an override command that can be provided to the computing system. In some embodiments of the concepts and technologies disclosed herein, the entire process of extracting and redacting sensitive personal information, and using that information to fulfill a request or order for the user, occurs in real-time, though this is not necessarily the case in all embodiments.

According to one aspect of the concepts and technologies disclosed herein, a system can be disclosed. The system can include a processor and a memory. The memory can store computer-executable instructions that, when executed by the processor, cause the processor to perform operations. The operations can include receiving a call associated with a customer, routing the call to an agent device, detecting, during the call, an impending disclosure of sensitive personal information of the customer, and generating sensitive data that corresponds to the sensitive personal information. The sensitive data can be generated based on sensitive audio of the call. The operations further can include providing modified audio to the agent device. As noted above, the providing of the modified audio to the agent device can occur in real-time, in some embodiments. The modified audio can include nonsensitive audio of the call, and the modified audio can omit the sensitive audio. The operations also can include providing the sensitive data to a call handling application that can be in communication with a computing device associated with the system and with the agent device.

In some embodiments, detecting the impending disclosure of the sensitive personal information of the customer can include receiving, from the agent device, a sensitive personal information event alert. The sensitive personal information event alert can indicate that the sensitive personal information is about to be disclosed. In some embodiments, the agent device can generate the sensitive personal information event alert in response to detecting a selection, at the agent device, of a field for entry of the sensitive personal information.

In some embodiments, the modified audio can include substitute audio that can replace the sensitive audio. Thus, the sensitive audio may not be provided to the agent device and the nonsensitive audio and the substitute audio may be provided to the agent device. Therefore, an agent at the agent device may not hear the sensitive audio, and the agent may hear the nonsensitive audio and the substitute audio. The substitution of audio can occur, in some embodiments, in real-time. In some embodiments, detecting the impending disclosure of the sensitive personal information of the customer can include performing, on call audio associated with the call, speech recognition to transcribe spoken words associated with the call, and detecting, via analysis of the spoken words, the impending disclosure of the sensitive personal information.

According to another aspect of the concepts and technologies disclosed herein, a method is disclosed. The method can include receiving, at a computing device including a processor, a call associated with a customer; routing, by the computing device, the call to an agent device; detecting, by the computing device and during the call, an impending disclosure of sensitive personal information of the customer; and generating, by the computing device, sensitive data that corresponds to the sensitive personal information. The sensitive data can be generated based on sensitive audio of the call. The method further can include providing, by the computing device, modified audio to the agent device. The modified audio can include nonsensitive audio of the call, and the modified audio can omit the sensitive audio. The method also can include providing, by the computing device, the sensitive data to a call handling application that can be in communication with the computing device and with the agent device.

In some embodiments, detecting the impending disclosure of the sensitive personal information of the customer can include receiving, from the agent device, a sensitive personal information event alert. In some embodiments, the agent device can generate the sensitive personal information event alert in response to detecting a selection, at the agent device, of a field for entry of the sensitive personal information. In some embodiments, the sensitive personal information event alert can indicate that the sensitive personal information is about to be disclosed.

In some embodiments, the method further can include assigning, to the call, a call identifier. The agent device can register the call with the computing device using the call identifier, and the call identifier can be used to identify the agent device that is to receive audio associated with the call. In some embodiments, the method further can include providing, by the computing device, the call identifier to the call handling application. The call identifier can be included in and/or with the sensitive data, and the call handling application can use the call identifier to correlate the sensitive data to nonsensitive data obtained from the agent device.

In some embodiments, the modified audio can include substitute audio that can replace the sensitive audio. Thus, the sensitive audio may not be provided to the agent device and the nonsensitive audio and the substitute audio may be provided to the agent device. Therefore, an agent at the agent device may not hear the sensitive audio, and the agent may hear the nonsensitive audio and the substitute audio. In some embodiments, the method further can include removing, from the call, identifying information associated with the customer; and assigning, to the call, a call identifier. The agent device can register the call with the computing device using the call identifier.

In some embodiments, detecting the impending disclosure of the sensitive personal information of the customer can include performing, on call audio associated with the call, speech recognition to transcribe spoken words associated with the call; and detecting, via analysis of the spoken words, the impending disclosure of the sensitive personal information. In some embodiments, the method further can include generating, by the computing device, a report. The report can indicate a number of calls received at the computing device, the calls including the call; a number of times among the calls that sensitive information has been shared during the calls; and a number of times that removal of the sensitive information has been overridden by agent devices including the agent device.

According to yet another aspect of the concepts and technologies disclosed herein, a computer storage medium is disclosed. The computer storage medium can store computer-executable instructions that, when executed by a processor, cause the processor to perform operations. The operations can include receiving a call associated with a customer, routing the call to an agent device, detecting, during the call, an impending disclosure of sensitive personal information of the customer, and generating sensitive data that corresponds to the sensitive personal information. The sensitive data can be generated based on sensitive audio of the call. The operations further can include providing modified audio to the agent device. The modified audio can include nonsensitive audio of the call, and the modified audio can omit the sensitive audio. The operations also can include providing the sensitive data to a call handling application that can be in communication with the computing device and with the agent device.

In some embodiments, detecting the impending disclosure of the sensitive personal information of the customer can include receiving, from the agent device, a sensitive personal information event alert. The sensitive personal information event alert can indicate that the sensitive personal information is about to be disclosed. In some embodiments, the agent device can generate the sensitive personal information event alert in response to detecting a selection, at the agent device, of a field for entry of the sensitive personal information.

In some embodiments, the modified audio can include substitute audio that can replace the sensitive audio. Thus, the sensitive audio may not be provided to the agent device and the nonsensitive audio and the substitute audio may be provided to the agent device. Therefore, an agent at the agent device may not hear the sensitive audio, and the agent may hear the nonsensitive audio and the substitute audio. In some embodiments, detecting the impending disclosure of the sensitive personal information of the customer can include performing, on call audio associated with the call, speech recognition to transcribe spoken words associated with the call, and detecting, via analysis of the spoken words, the impending disclosure of the sensitive personal information.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a line drawing that schematically illustrates aspects of the extraction and redaction of sensitive information from audio, according to an illustrative embodiment of the concepts and technologies disclosed herein.

FIG. 3 is a flow diagram showing aspects of a method for extracting and redacting sensitive information from audio, according to an illustrative embodiment of the concepts and technologies described herein.

FIG. 4 is a flow diagram showing aspects of a method for extracting and redacting sensitive information from audio, according to an illustrative embodiment of the concepts and technologies described herein.

FIG. 5 is a flow diagram showing aspects of a method for extracting and redacting sensitive information from audio, according to an illustrative embodiment of the concepts and technologies described herein.

FIG. 6 is a flow diagram showing aspects of a method for extracting and redacting sensitive information from audio, according to an illustrative embodiment of the concepts and technologies described herein.

FIGS. 7A-7C are user interface diagrams showing various screen displays for use in various embodiments of the concepts and technologies disclosed herein for extracting and redacting sensitive information from audio, according to some illustrative embodiments of the concepts and technologies described herein.

FIG. 8 schematically illustrates a network, according to an illustrative embodiment of the concepts and technologies described herein.

FIG. 9 is a block diagram illustrating an example computer system configured to extract and redact sensitive information from audio, according to some illustrative embodiments of the concepts and technologies described herein.

FIG. 10 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to extracting and redacting sensitive information from audio. A call can be received at a call center, a phone system, or a component of a call center or phone system such as, for example a communication gateway. In some embodiments, the communication gateway can be configured to remove identifying information associated with the call (e.g., data identifying a customer device used to connect to the call center, data identifying a customer associated with the customer device, a phone number associated with the customer, combinations thereof, or the like) from the call and/or data associated with the call. The communication gateway can be configured in some embodiments to assign a call identifier to the call. The call identifier can be used instead of, or in addition to, the identifying information. The communication gateway or other infrastructure of the call center or phone system can connect the call to a device such as, for example, a computing device that can execute or host a speech recognition engine and an extraction and redaction engine.

An agent that is to handle the call can be identified and the call can be connected to the agent device associated with the agent. Although the call has been routed to the agent device, embodiments of the concepts and technologies disclosed herein enable the computing device to analyze audio associated with the call, to detect an impending exchange of sensitive personal information, to modify audio associated with the call before passing a modified version of the audio to the agent device, and to generate sensitive data that represents the sensitive personal information. In particular, the speech recognition engine can perform speech recognition on the audio associated with the call during the entirety of the call and/or at particular times during the call. Output from the speech recognition engine can be provided to the extraction and redaction engine. The extraction and redaction engine can be configured to determine, based on output from the speech recognition engine (e.g., text associated with the call, etc.), that sensitive personal information is about to be disclosed during the call.

The extraction and redaction engine can remove, from audio associated with the call, the sensitive audio that corresponds to the sensitive personal information, and provide modified audio to the agent device as part of the modified call. The modified audio can include substitute audio and/or otherwise may omit the sensitive audio. The extraction and redaction engine can generate sensitive data that represents the sensitive personal information and provide the sensitive data to the call handling application. An agent application executed by an agent device handling the call can be configured to generate nonsensitive data that represents nonsensitive information and provide the nonsensitive data to the call handling application.

The call handling application can generate call data and provide the call data to one or more backend systems for implementation (e.g., to pay a bill, to create an order, to provision services, etc.). The extraction and redaction engine also can include functionality for generating reports, and can provide the reports to one or more recipients. In some embodiments, the agent can have the ability to bypass or deactivate the functionality of the extraction and redaction engine, for example, by generating an override command that can be provided to the computing system.

As used herein, the phrase “real-time” is used to a refer to a process in which input (e.g., a user's spoken speech during a telephone call) is processed (e.g., the sensitive portions of the user's speech are removed, optionally substituted, and the sensitive information is captured and/or used) within a small number of milliseconds such that the process occurs virtually immediately. In some embodiments, for example, the number of milliseconds can include a number within a range of less than one to five milliseconds; a range of five to twenty milliseconds; or a range of up to fifty milliseconds. It should be understood that these examples are illustrative, and therefore should not be construed as being limiting in any way. In some embodiments of the concepts and technologies disclosed herein, the entire end-to-end process illustrated and described herein (from the time sensitive audio is received to the time data capturing sensitive information associated with the sensitive audio is provided to one or more backend devices or other entities) can occur in real-time. Because real-time processing is a preferred embodiment, and is not required in all embodiments of the concepts and technologies disclosed herein, it should be understood that the real-time examples provided herein are illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

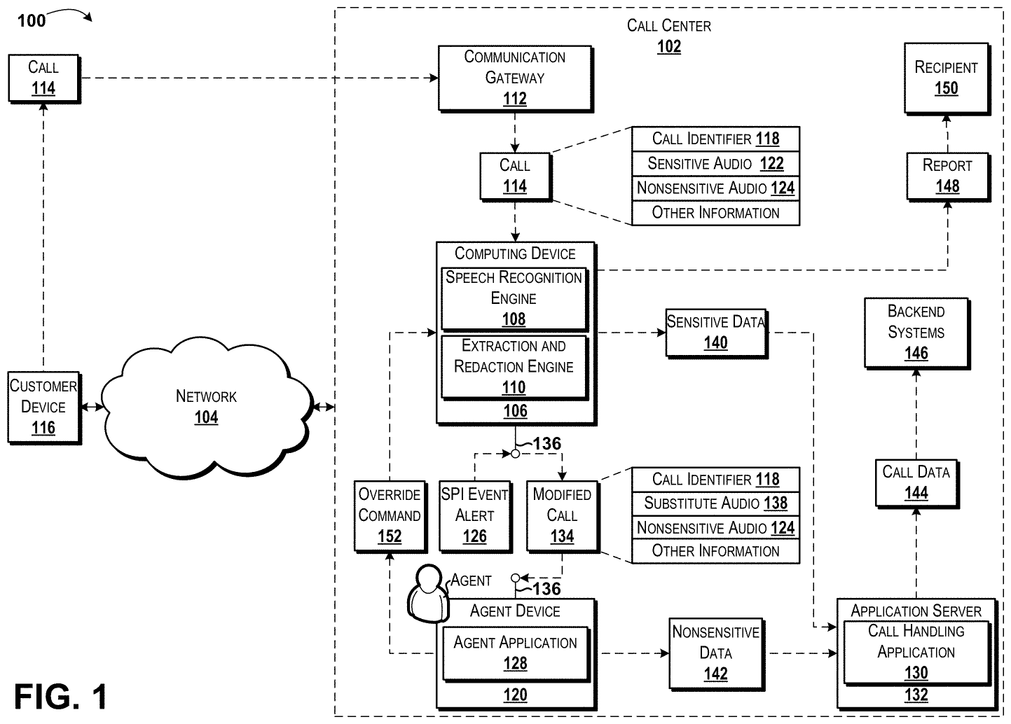

Referring now to FIG. 1, aspects of an operating environment 100 for various embodiments of the concepts and technologies disclosed herein for extracting and redacting sensitive information from audio will be described, according to an illustrative embodiment. The operating environment 100 shown in FIG. 1 includes a call center 102. The call center 102 can operate in communication with and/or as part of one or more communications networks (“network”) 104.

According to various embodiments of the concepts and technologies disclosed herein, the call center 102 can include a number of devices. It should be appreciated that the call center 102 can include many devices and/or modules that are not illustrated in FIG. 1. For simplicity and ease of description, only several devices are illustrated and described herein as operating in the call center 102. Furthermore, it should be understood that the various devices illustrated and described herein as being located at the call center 102 can be located outside of the call center 102 and can communicate with each other and/or other devices via one or more networks such as, for example, the network 104. Additionally, or alternatively, the devices illustrated and described herein as operating as part of and/or in communication with the call center 102 can be located in one or more call centers 102, and those devices can communicate with each other via various networking technologies.

Because the concepts and technologies disclosed herein can be implemented in other organizations and/or systems (other than a call center 102), it should be understood that the illustrated embodiment is illustrative. For example, in one contemplated embodiment, the concepts and technologies disclosed herein for extracting and redacting sensitive information from audio can be implemented in a phone system, an IVR for a business, etc. As such, it should be understood that the illustrated and described embodiment is illustrative, and therefore should not be construed as being limiting in any way.

According to various embodiments, the call center 102 can include a computing device 106. In various embodiments of the concepts and technologies disclosed herein, the functionality of the computing device 106 may be provided by one or more server computers, desktop computers, mobile telephones, laptop computers, set-top boxes, other computing systems, and the like. It should be understood that the functionality of the computing device 106 can be provided by a single device, by two similar devices, and/or by two or more dissimilar devices. For purposes of describing the concepts and technologies disclosed herein, the computing device 106 is described herein as a server computer. It should be understood that this embodiment is illustrative, and should not be construed as being limiting in any way.

The computing device 106 can execute an operating system (not shown in FIG. 1) and one or more application programs such as, for example, a speech recognition engine 108 and an extraction and redaction engine 110. The operating system can include a computer program for controlling the operation of the computing device 106. The speech recognition engine 108 and the extraction and redaction engine 110 can include executable programs that can be configured to execute on top of the operating system to provide various functions as illustrated and described herein. The functionality of the speech recognition engine 108 and the extraction and redaction engine 110 will be described in more detail below after introducing additional elements of the call center 102.

The call center 102 further can include an interface or other device that can interface with one or more networks (e.g., the network 104 and/or other communications networks) and/or one or more network connections. In various embodiments of the concepts and technologies disclosed herein, the interface for the call center 102 can include, for example, a communication gateway 112. The communication gateway 112 can be configured to receive (and/or send) communications such as, for example, a call 114 and/or signaling and/or information associated with the call 114. According to various embodiments of the concepts and technologies disclosed herein, the call 114 can be received from any type of communications network and/or device and therefore can include cell phone calls, traditional telephone line calls, voice over IP (“VoIP”) calls, or other calls that may be received via direct dial and/or via an interactive voice response (“IVR”) device.

In some embodiments, the call 114 can be received at the communication gateway 112 in response to a customer and/or other entity dialing a direct dial number associated with the call center 102, via an IVR or other functionality routing the call 114 to the call center 102, and/or in other manners (e.g., call transfers, call forwarding, or the like). Because the call 114 can be received at the communication gateway 112 in additional and/or alternative manners, it should be understood that these examples are illustrative, and therefore should not be construed as being limiting in any way.

According to some embodiments of the concepts and technologies disclosed herein, the call 114 can include data that can identify a calling party and/or a device associated with the calling party such as, for example, a customer device 116. In various embodiments, functionality of the customer device 116 may be provided by one or more computers, mobile telephones, laptop computers, tablet computers, telephones, other computing systems, other communications devices, combinations thereof, or the like. For purposes of describing the concepts and technologies disclosed herein, the customer device 116 will be described herein as a mobile telephone or smartphone. It should be understood that this embodiment is illustrative, and should not be construed as being limiting in any way.

The call 114 received at the communication gateway 112 can include information such as, for example, signaling and/or identification information such as call setup information, IP address information, media access control (“MAC”) address information (e.g., a MAC ID), callerID information, device identifiers, combinations thereof, or the like. In some embodiments, the information included in and/or as part of the call 114 can be used to identify the calling party and/or a device associated with the calling party. In the illustrated embodiment, for example, the information can identify the customer, the customer device 116, a device identifier associated with the customer device 116, authentication information, combinations thereof, or the like. Because the customer and/or other entity associated with the customer device 116 can be identified in additional and/or alternative manners, it should be understood that these examples are illustrative and therefore should not be construed as being limiting in any way.

The communication gateway 112 can be configured to receive the call 114 and, in some embodiments, to assign to the call 114 a call identifier 118 that can be used to identify the customer and/or an account associated with the customer. In some embodiments of the concepts and technologies disclosed herein, the call identifier 118 can include a call reference number or other reference that can be used to identify the call 114 and/or associate information associated with the call 114, and the customer's true identity may or may not be disclosed to agents, agent devices 120, and/or other entities involved in handling the call 114.

In some embodiments, the computing device 106 can store an association or other data that links the call identifier 118 to the call 114, the customer, and/or the customer device 116, though this is not necessarily the case in all embodiments. Thus, it can be appreciated that the call identifier 118 can be used in some embodiments to anonymize the call 114, for tracking of the call 114, to associate data generated in association with the call 114 at two or more devices, and/or for other purposes. Because the call identifier 118 can be used for additional and/or alternative purposes, and because the call identifier 118 can be used instead of or in conjunction with other identifying information, it should be understood that these examples are illustrative, and therefore should not be construed as being limiting in any way.

The communication gateway 112 can connect the call 114 with the computing device 106 and/or other devices, as will be explained in more detail herein. In some embodiments, the computing device 106 can identify an agent that is to handle the call 114 and connect the call 114 to the identified agent. In some other embodiments, other infrastructure of the call center 102 can identify the agent that is to handle the call 114. Thus, the computing device 106 may not be involved in routing the call 114 and/or selecting an agent in various embodiments of the concepts and technologies disclosed herein. In various embodiments, the agent can be selected randomly, based on agent availability, and/or based on other approaches (e.g., a “round robin” assignment scheme, based on active/inactive time, etc.). Regardless of what entity identifies the agent, an agent device 120 associated with the identified agent can also be identified.

The computing device 106 or other infrastructure of the call center 102 can connect the call 114 with the identified agent device 120 and call handling by the agent can commence once the call 114 has been connected and/or registered as will be explained in more detail below. The “call handling” referred to herein can include an exchange of audio data and associated information (“audio”) associated with the call 114 between the agent device 120 and the customer device 116 to resolve an issue or issues for which the customer initiated the call 114 to the call center 102 (or the call 114 that was eventually routed to the call center 102 as noted above). As will be explained in more detail herein, the audio associated with the call 114 can pass through the computing device 106 during call handling by the agent device 120, and the computing device 106 can perform various operations on the audio associated with the call 114 during call handling by the agent device 120.

In particular, it can be appreciated that the audio associated with a call 114 can include multiple instances of data and/or one or more streams of audio (e.g., telephone calls, VoIP calls, etc.). Furthermore, it should be understood that the audio associated with the call 114 can include two-way communications of audio information, signaling, and/or other data. According to various embodiments of the concepts and technologies disclosed herein, the call 114 can include, but is not limited to, the call identifier 118, sensitive audio 122, nonsensitive audio 124, and other information such as signaling data, call setup data, time information, dual tone multi frequency (“DTMF”) tones, other data, combinations thereof, or the like. Because other information can be included in the audio associated with the call 114 and/or other data that corresponds to the call 114, it should be understood that these examples are illustrative, and therefore should not be construed as being limiting in any way.

The sensitive audio 122 can include sound that represents and/or constitutes potentially sensitive information such as, for example, spoken information, DTMF tones, or other audio that can correspond to credit card numbers, social security numbers, dates of birth, telephone personal identification numbers (“PINs”), driver's license numbers, and/or other potentially sensitive information. The nonsensitive audio 124 can include spoken information, DTMF tones, or other audio that can correspond to mundane information and/or other information that is not potentially sensitive (e.g., information that is not defined as sensitive audio 122).

For example, if, during a phone call or other communication that involves the transmission of sound, a user says “Hello, my name is Betty Davis and my social security number is 123-45-6789,” embodiments of the concepts and technologies disclosed herein can be used to define the audio corresponding to the words “Hello, my name is” and/or “my social security number is” as being nonsensitive audio 124. Similarly, embodiments of the concepts and technologies disclosed herein can be used to define the audio corresponding to the words “Betty Davis” and/or “123-45-6789” as being sensitive audio 122. Based on these identifications, embodiments of the concepts and technologies disclosed herein can be used to protect, extract, save, redact, and/or use the sensitive and/or nonsensitive information. It should be understood that this example is illustrative, and therefore should not be construed as being limiting in any way.

According to various embodiments of the concepts and technologies disclosed herein, the extraction and redaction engine 110 can be configured to perform various functions as illustrated and described herein. In some embodiments, the extraction and redaction engine 110 can identify sensitive information, remove and/or redact sensitive information from audio being passed to certain other entities (e.g., the agent device 120), and provide sensitive information in one or more formats to other entities for use. As used herein, the word “extract” when used with reference to the extraction and redaction engine 110 can refer to identifying and saving information (e.g., sensitive information reflected in the sensitive audio 122). As used herein, the word “redact” when used with reference to the extraction and redaction engine 110 can refer to removing or obscuring audio and/or substituting audio for the sensitive audio 122 before passing audio associated with the call 114 to other entities.

In various embodiments, the extraction and redaction engine 110 can communicate with and/or can incorporate in some embodiments, speech recognition functionality such as, for example, the speech recognition engine 108. The speech recognition engine 108 can be configured to perform speech recognition on the audio and other data associated with the call 114 as the audio and other data associated with the call 114 arrives at and/or passes through the computing device 106. In some embodiments, as noted above, the audio and other data associated with the call 114 can stream through the computing device 106 during the call 114, and as such, the speech recognition engine 108 can perform speech recognition on the audio stream. According to various embodiments, the extraction and redaction engine 110 can be configured to perform contextual analysis on output from the speech recognition engine 108. The extraction and redaction engine 110 also can be configured to perform various operations on audio associated with the call 114 based on the contextual analysis and/or based on other information as illustrated and described herein.

According to various embodiments of the concepts and technologies disclosed herein, the extraction and redaction engine 110 can be configured to detect, based on the analysis of the output from the speech recognition engine 108, a potential impending disclosure of sensitive information before the actual disclosure of the potentially sensitive information occurs. More particularly, the extraction and redaction engine 110 can predict an impending disclosure of sensitive information during a call 114 (before the sensitive information is said or heard), and can perform operations to prevent the disclosure of the sensitive information to some entities (e.g., to the agent associated with the agent device 120) during the call 114.

Because this identification, extraction, and redaction can occur in real-time and/or in near real-time (e.g., with almost no delay), the customer may be unaware of the redaction of certain audio, thereby protecting the customer experience. In some contemplated embodiments of the concepts and technologies disclosed herein, the delay in audio added by using the extraction and redaction engine 110 can be in a range of one to one hundred milliseconds and therefore may be nearly undetectable. In some other embodiments, the delay may be longer, but the customer may nonetheless be unaware of the redaction and extraction functionality illustrated and described herein. It should be understood that this example is illustrative, and therefore should not be construed as being limiting in any way.

According to some embodiments, the extraction and redaction engine 110 can detect a potential impending disclosure of sensitive information based on analyzing output from the speech recognition engine 108. In some embodiments, for example, output from the speech recognition engine 108 (or a speech and recognition application or module if included in the extraction and redaction engine 110) can include a transcribed text associated with a call 114, or the like, and the extraction and redaction engine 110 can be configured to determine, based on analysis of that text, that a disclosure of sensitive information is about to occur. For example, if a caller says “my social security number is,” the extraction and redaction engine 110 can determine that the next words spoken, if numbers, are likely to correspond to a social security number and therefore can extract and redact (from the audio associated with the call 114), the spoken numbers. It should be understood that this example is illustrative, and therefore should not be construed as being limiting in any way.

In some other embodiments, the computing device 106 can receive a notification or alert, for example a sensitive personal information (“SPI”) event alert 126 (labeled “SPI event alert 126” in FIG. 1). The sensitive personal information event alert 126 can be used to indicate that a potential disclosure of sensitive information is about to occur. The extraction and redaction engine 110 can be configured to determine, based on receiving the sensitive personal information event alert 126, that a disclosure of sensitive information is about to occur. In response to receiving the sensitive personal information event alert 126, the extraction and redaction engine 110 can be configured to analyze the text associated with the call 114, to begin extracting and/or redacting audio, and/or other functionality as illustrated and described herein. Thus, in some embodiments the extraction and redaction engine 110 can analyze all text associated with the call 114 to identify potentially sensitive information, while in other embodiments the extraction and redaction engine 110 can be invoked in response to receiving the sensitive personal information event alert 126. In either event, various embodiments of the extraction and redaction engine 110 illustrated and described herein can be configured to detect the impending disclosure of sensitive information before the disclosure occurs.

According to various embodiments of the concepts and technologies disclosed herein, as noted above, the call 114 can be routed to the agent device 120 and the agent device 120 can register the call 114 with the computing device 106. Registration of the call 114 can include the agent device 120, for example via execution of an executable program such as the agent application 128, providing the call identifier 118 to the computing device 106, whereby the computing device 106 can associate the audio and other data associated with the call 114 with the agent device 120. While only one agent device 120 is shown in FIG. 1, it can be appreciated that tens, hundreds, or even thousands of agent devices 120 may exist in an embodiment of the operating environment 100, and therefore the registration operation can be used to ensure that the appropriate audio and other data associated with the call 114 is routed to the appropriate agent device 120. Additionally, as noted above, it should be understood that infrastructure of the call center 102 can route the call 114 to the agent device 120 and/or handle registration of the call 114 at the agent device 120. As such, the illustrated embodiment is illustrative and should not be construed as being limiting in any way.

During handling of the call 114, the agent device 120 can be used to interact with another application that can be external to and/or remote from the agent device 120 such as, for example, a call handling application 130. As shown in FIG. 1, the call handling application 130 can correspond in some embodiments to a server application that can be hosted by and/or executed by a computer, such as the application server 132. The functionality of the application server 132 can be provided by one or more server computers, desktop computers, laptop computers, other computing systems, and the like. It should be understood that the functionality of the application server 132 can be provided by a single device, by two similar devices, and/or by two or more dissimilar devices. For purposes of describing the concepts and technologies disclosed herein, the application server 132 is described herein as a server computer. It should be understood that this embodiment is illustrative, and should not be construed as being limiting in any way.

According to various embodiments, the agent device 120 can interact with the call handling application 130 via a portal, a web page, an application programming interface (“API”), and/or via another interface during the call 114. As shown in FIG. 1, the agent device 120 can receive, during the call 114, a modified version of the call audio (“modified call”) 134. In particular, as noted above, the call 114 can flow through the computing device 106 and can be connected to the agent device 120, but according to various embodiments of the concepts and technologies disclosed herein, the computing device 106 can modify some, none, or all of the call 114 and provide the modified call 134 to the agent device 120.

In some embodiments, a web socket, portal, one or more APIs, micro-services, and/or other interface (hereinafter referred to the “agent interfaces”) 136 can enable communications between the agent device 120 and the computing device 106. Thus, the agent interfaces 136 can exist on the agent device 120 and/or on the computing device 106. Audio and/or data exchanged between the computing device 106 and the agent device 120 (e.g., the sensitive personal information event alert 126 and/or the modified call 134) can be sent and/or received via the agent interfaces 136. It should be understood that this example is illustrative, and therefore should not be construed as being limiting in any way.

According to various embodiments, the modified call 134 that can be provided to the agent device 120 can be substantially similar to the audio associated with the call 114, except that any sensitive audio 122 associated with the call 114 may not be included in (or may be removed from) the modified call 134. Thus, it can be appreciated that the modified call 134 can include a modified version of the audio associated with the call 114. In particular, the modified call 134 can include the nonsensitive audio 124 but can exclude and/or may not include the sensitive audio 122. Furthermore, in some embodiments, as will be explained herein, the modified call 134 can also include substitute audio 138. It should be understood that this example is illustrative, and therefore should not be construed as being limiting in any way.

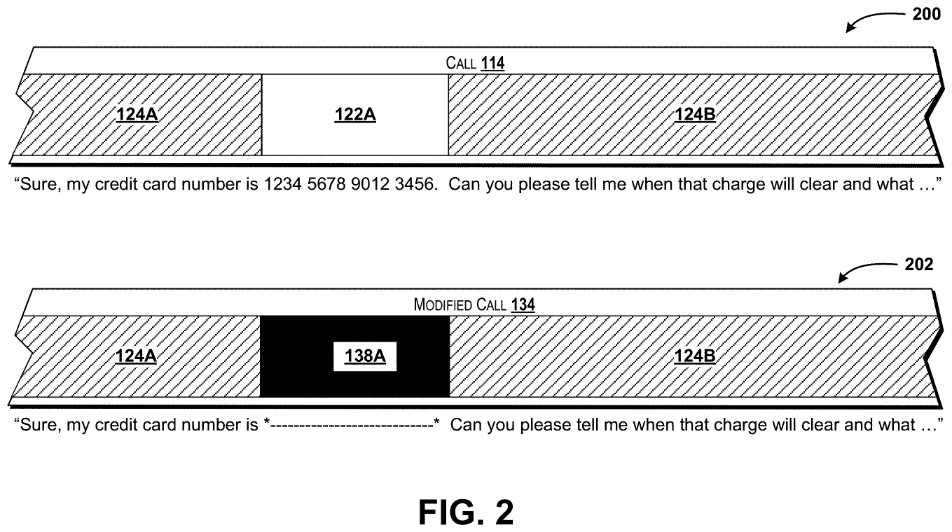

In some embodiments, the speech recognition engine 108 or the extraction and redaction engine 110 can analyze the audio and other data associated with the call 114 substantially constantly and substantially in real-time (or near real-time) to identify potentially sensitive audio 122. Alternatively, as noted above, the computing device 106 can receive the sensitive personal information event alert 126 during the call 114 and can determine that sensitive information is about to be disclosed. In response to determining that sensitive information is about to be disclosed during the call 114, the computing device 106 can, via the extraction and redaction engine 110, search for and/or identify sensitive audio 122 that corresponds to the sensitive information and remove that sensitive audio 122 from audio being provided to the agent device 120 during the call 114. The removal and/or substitution of audio associated with the call 114 will be illustrated and described in more detail below with reference to FIG. 2.

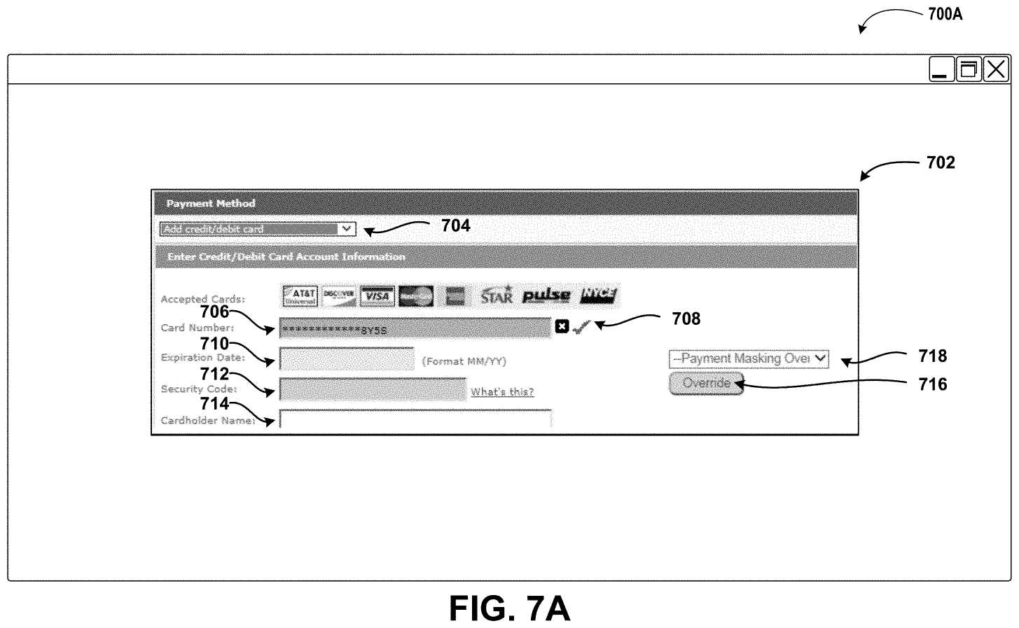

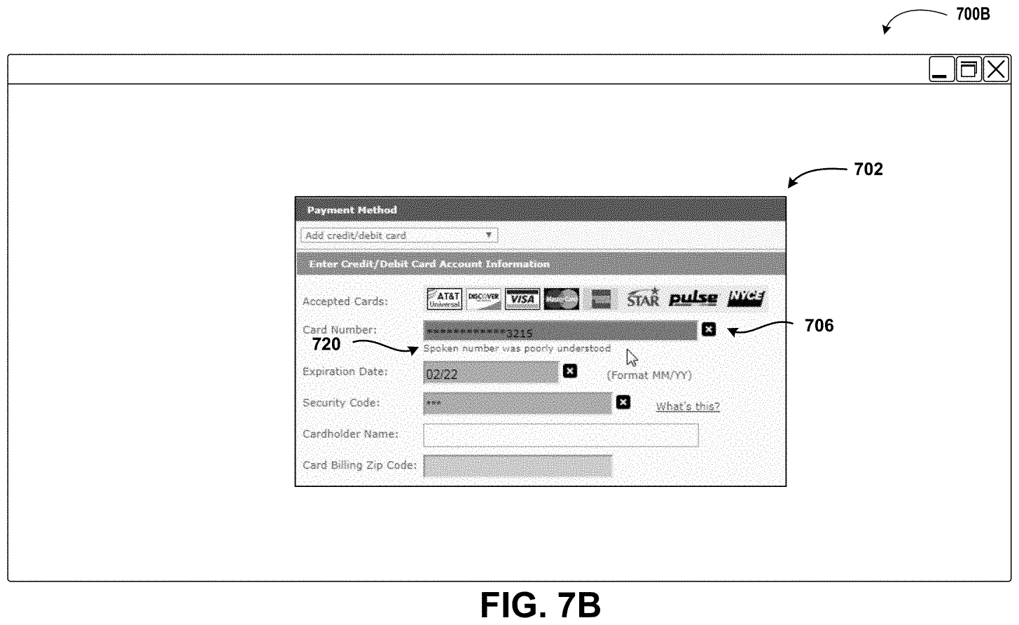

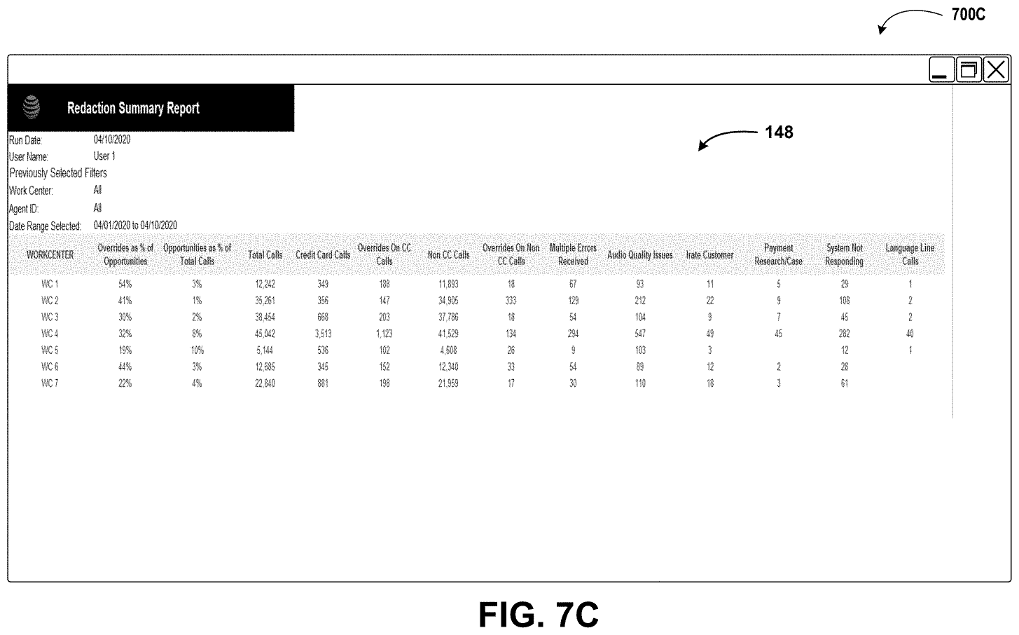

According to various embodiments, the agent application 128 executed by the agent device 120 can detect selection of a field, text entry box, or other functionality for entering potentially sensitive information such as, for example, a credit card number, a social security number, or the like. According to various embodiments of the concepts and technologies disclosed herein, the call handling application 130 can provide a web interface (e.g., an internal website, a web portal, etc.) or other functionality for capturing information (including potentially sensitive information). In some embodiments, the web page, portal, or other functionality can include a field that, when selected by the agent at the agent device 120, causes the agent device 120, the application server 132, or other device to generate the sensitive personal information event alert 126. Some example embodiments of such a field will be illustrated and described herein with reference to FIGS. 7A-7B.

Such a field can be selected, for example, by an agent handling a call 114 when the agent is about to obtain sensitive information from a customer (e.g., a credit card number, a social security number, or the like), where selection of the field can enable entry, by the agent, of the sensitive information such as spoken credit card numbers, spoken social security numbers, or the like. In some embodiments of the concepts and technologies disclosed herein, the sensitive information also can be entered using DTMF or other tones, if desired. Because the sensitive personal information event alert 126 can be generated in additional and/or alternative manners, it should be understood that the above example is illustrative, and therefore should not be construed as being limiting in any way.

In response to detecting the impending disclosure of sensitive information (e.g., in response to receiving the sensitive personal information event alert 126, in response to detecting, in output from the speech recognition engine 108, the impending disclosure, and/or in response to otherwise detecting the impending disclosure), the extraction and redaction engine 110 can monitor the call 114 and identify, in real-time or near real-time, the disclosure of the sensitive information (e.g., the sensitive audio 122). Because the extraction and redaction engine 110 can operate in real-time and/or in near real-time, the sensitive audio 122 can be identified by the extraction and redaction engine 110 before the agent associated with the agent device 120 hears the sensitive information. The extraction and redaction engine 110 can extract, from the audio associated with the call 114, the sensitive audio 122 and redact the audio associated with the call 114 to create the modified call 134 as noted above, and as will be schematically illustrated and described in more detail with reference to FIG. 2 below.

In some embodiments, the extraction and redaction engine 110 can remove the sensitive audio 122 from audio associated with the call 114 and provide other audio associated with the call 114 (e.g., the nonsensitive audio 124) to the agent device 120. In some other embodiments, the extraction and redaction engine 110 can create the modified call 134 by adding the nonsensitive audio 124 to the modified call 134 (thereby preventing disclosure of the sensitive information in a different manner). Because the extraction and redaction engine 110 can prevent disclosure of the sensitive information in additional and/or alternative manners, it should be understood that this example is illustrative, and therefore should not be construed as being limiting in any way.

According to various embodiments, the extraction and redaction engine 110 can be configured to insert substitute audio 138 into the modified call 134 in place of the removed sensitive audio 122. According to various embodiments, the substitute audio 138 can include, for example, spoken words, soft tones, hard tones, music, or other audio. The substitute audio 138 can be included, in some embodiments, to inform an agent associated with the agent device 120 that the sensitive information is being provided and recognized, that the call 114 is still in progress, and/or for other reasons (e.g., the spoken words can provide instructions and/or information to the agent). Because the substitute audio 138 can be inserted for additional and/or alternative reasons, it should be understood that the above examples are illustrative, and therefore should not be construed as being limiting in any way.

In some embodiments, the modified call 134 also can include other information such as, for example, ghost characters or other indicators for reflecting the collection of sensitive information by the extraction and redaction engine 110. For example, the modified call 134 can include data that will cause asterisks or other characters to appear in a field. These characters can reflect the capturing of digits of a credit card number or social security number as they are received (e.g., one character per one digit), thereby informing the agent of progress in the process of obtaining the sensitive information. Because such characters can be populated in additional and/or alternative manners, it should be understood that this example is illustrative, and therefore should not be construed as being limiting in any way.

Additionally, the extraction and redaction engine 110 can capture and/or otherwise extract the sensitive information reflected by the sensitive audio 122 and can generate, based on the sensitive audio 122, the sensitive data 140. The sensitive data 140 can correspond, in some embodiments, to the sensitive information (e.g., credit card numbers, social security numbers, or the like) that can be captured by the speech recognition engine 108 and/or other functionality. The extraction and redaction engine 110 can be configured to transmit the sensitive data 140 to the application server 132 out-of-band relative to the agent device 120, meaning that the sensitive data 140 can be provided to the call handling application 130 without the agent device 120 receiving and/or being exposed to the sensitive information associated with the sensitive data 140.

According to various embodiments, the sensitive data 140 can include, for example, one or more character strings that can correspond to a credit card number, expiration date, birthdate information, date information, associated ZIP codes, cardholder names, security codes, bank account information, PIN or password information, authentication information, and/or other information associated with a payment account; one or more character strings that can correspond to a social security number, passport numbers, a driver's license number, and/or other identifying information; one or more character strings that can correspond to other sensitive information; combinations thereof; or the like. Because additional and/or alternative sensitive information can be captured and/or can be represented in other manners (e.g., objects, binary, etc.), it should be understood that the above example embodiments of the sensitive data 140 are illustrative, and therefore should not be construed as being limiting in any way.

The agent application 128 also can be configured to capture information during the call 114. As shown in FIG. 1, the agent application 128 can capture the nonsensitive audio 124 and can generate nonsensitive data 142 associated with the call 114. The agent device 120 can provide (via the portal, website, or otherwise), the nonsensitive data 142 to the call handling application 130. The call handling application 130 can use the sensitive data 140 and the nonsensitive data 142 to complete an order or other action associated with the call 114 (e.g., an order for new services, a payment, a change to an account, etc.). Thus, while the sensitive data 140 may include data identifying payment information or other sensitive information, the nonsensitive data 142 can include data identifying voice plans, data plans, etc. In some embodiments, the call identifier 118 can be provided to the call handing application 130 with the sensitive data 140 and with the nonsensitive data 142, thereby enabling the call handling application 130 to correlate sensitive information associated with the call 114 with the nonsensitive information associated with the call 114. Because this correlation may be omitted and/or may occur in other manners, it should be understood that this example is illustrative, and therefore should not be construed as being limiting in any way.

According to various embodiments, the call handling application 130 can generate call data 144 based on the sensitive data 140, the nonsensitive data 142, and/or other input and/or output from the agent application 128. The call handling application 130 can send the call data 144 to one or more backend systems 146 for implementation in accordance with the call 114. Thus, for example, it can be appreciated that the backend systems 146 can include, for example, provisioning entities, order entities, billing entities, account management entities, combinations thereof, or the like. It should be understood that these examples are illustrative, and therefore should not be construed as being limiting in any way.

According to various embodiments of the concepts and technologies disclosed herein, the extraction and redaction engine 110 also can be configured to provide a reporting mechanism for call redaction and/or information extraction from the calls 114. According to various embodiments, the extraction and redaction engine 110 can be configured to track a number of calls 114 that are handled by one or more agent devices 120, a number of times the extraction and redaction engine 110 functionality for redacting sensitive audio 122 from calls 114 has been invoked during handling of those calls 114, and various performance metrics associated with the extraction and redaction engine 110.

Performance metrics can include, but are not limited to, a number of times the extraction and redaction engine 110 functionality for redacting sensitive audio 122 from calls 114 has been turned off and/or overridden during calls 114 (e.g., due to a failure of the extraction and redaction engine 110), a number of override opportunities that have occurred during the calls 114, a number of calls 114 that involved the obtaining of credit card and/or other payment information, a number of overrides during calls 114 that involved the obtaining of credit card and/or other payment information, a number of errors detected and/or logged, a number of audio quality issues detected and/or logged, a number of payment research requests detected and/or logged, a number of times the functionality for redacting sensitive audio 122 from calls 114 has been deactivated based on a language issue (e.g., some foreign languages may be supported by embodiments of the extraction and redaction engine 110, while other foreign languages may not be supported), a number of irate customers detected and/or logged, and/or other information relating to the performance of the extraction and redaction engine 110.

The report 148 can be generated by the extraction and redaction engine 110 and provided to one or more recipient devices (“recipient”) 150. Because the report 148 can be provided to other entities and/or used for other purposes, it should be understood that this example is illustrative, and therefore should not be construed as being limiting in any way. An example embodiment of a report 148 that can be generated in accordance with an example embodiment of the concepts and technologies disclosed herein will be illustrated and described below with reference to FIG. 7C. Because other information can be captured by the extraction and redaction engine 110, and because other information can be reflected in the report 148, it should be understood that the above-noted examples are illustrative, and therefore should not be construed as being limiting in any way.

In various embodiments of the concepts and technologies disclosed herein, the agent device 120 also can be configured to support overriding of the functionality of the extraction and redaction engine 110. In some embodiments, for example where an audio problem may exist, the speech recognition engine 108 and/or the extraction and redaction engine 110 may not function as intended. The agent can have the ability, in some embodiments, to deactivate the extraction and redaction engine 110 to prevent the sensitive audio 122 from being redacted from the call 114 (and/or modified call 134). Thus, the agent application 128 can be configured to generate a command to deactivate or override the extraction and redaction engine 110 (“override command”) 152, in some embodiments. Upon receiving the override command 152, the computing device 106 can deactivate the functionality of the extraction and redaction engine 110 on the call 114 being handled by the agent device 120 that sent the override command 152. The extraction and redaction engine 110 can be deactivated for the duration of the call 114, until the instance of sensitive personal information has been received, and/or for other durations.

In practice, a call 114 can be received at a call center 102, for example at the communication gateway 112. In some embodiments, the communication gateway 112 can remove, from the call 114 and/or data associated with the call 114, identifying information associated with the call 114 (e.g., data identifying a customer device 116 used to connect to the call center 102, data identifying a customer associated with the customer device 116, a phone number associated with the customer, combinations thereof, or the like). In some embodiments, the communication gateway 112 can assign a call identifier 118 to the call 114. In some other embodiments, the identifying information associated with the call 114 may not be removed, and this identifying information can be used during the call 114 alone or in combination with the call identifier 118, if assigned. At any rate, the call 114 can be connected to a device such as, for example, the computing device 106.

The computing device 106 can host or execute the speech recognition engine 108 and the extraction and redaction engine 110. The computing device 106 or other infrastructure associated with the call center 102 can identify an agent that is to handle the call 114 and can connect the call 114 to the agent device 120 associated with the agent. Although the call 114 has been routed to the agent device 120, embodiments of the concepts and technologies disclosed herein analyze audio associated with the call 114 before passing the audio (or a modified version of the audio) to the agent device 120 as the modified call 134. In particular, the speech recognition engine 108 can perform speech recognition on the audio associated with the call 114 during the entirety of the call 114 and/or at particular times during the call 114. Output from the speech recognition engine 108 can be provided to the extraction and redaction engine 110.

The extraction and redaction engine 110 can be configured to determine, based on output from the speech recognition engine 108 (e.g., text associated with the call 114, etc.), that sensitive personal information is about to be disclosed during the call 114. The extraction and redaction engine 110 can remove, from audio associated with the call 114, the sensitive audio 122 that corresponds to the sensitive personal information, and provide modified audio to the agent device 120 as part of the modified call 134. As noted above, the modified audio can include the substitute audio 138 and/or otherwise may omit the sensitive audio 122. The extraction and redaction engine 110 can generate sensitive data 140 that represents the sensitive personal information and provide the sensitive data 140 to the call handling application 130. The agent application 128 can generate nonsensitive data 142 that represents nonsensitive information and provide the nonsensitive data 142 to the call handling application 130.

The call handling application 130 can generate call data 144 and provide the call data 144 to one or more backend systems 146 for implementation. The extraction and redaction engine 110 also can include functionality for generating reports 148, and can provide the reports 148 to one or more recipients 150. In some embodiments, the agent can have the ability to bypass or deactivate the functionality of the extraction and redaction engine 110, for example by generating an override command 152 that can be provided to the computing device 106.

FIG. 1 illustrates one call center 102, one network 104, one computing device 106, one communication gateway 112, one customer device 116, one agent device 120, one application server 132, one instance of backend systems 146, and one recipient 150. It should be understood, however, that various implementations of the operating environment 100 can include one or more than one call center 102; one or more than one network 104; one or more than one computing device 106; zero, one, or more than one communication gateway 112; zero, one, or more than one customer device 116; zero, one, or more than one agent device 120; zero, one, or more than one application server 132; zero, one, or more than one instance of backend systems 146; and/or zero, one, or more than one recipient 150. As such, the illustrated embodiment should be understood as being illustrative, and should not be construed as being limiting in any way.

Turning now to FIG. 2, additional aspects of the concepts and technologies disclosed herein will be described. In particular, FIG. 2 schematically illustrates an example of audio 200 associated with the call 114. As shown in FIG. 2, the audio 200 can include a first instance of nonsensitive audio 124A, a first instance of sensitive audio 122A, and a second instance of nonsensitive audio 124B. It can be appreciated that multiple instances of sensitive audio 122 and nonsensitive audio 124 may be included, and that the illustrated example is merely illustrative and is provided for illustration purposes only. As shown in FIG. 2, these instances of audio can correspond to the spoken words illustrated under the schematic representation of the call 114. As can be appreciated with reference to FIG. 2, the phrase “Sure, my credit card number is” can correspond to the first instance of nonsensitive audio 124A; the phrase “1234 5678 9012 3456” can correspond to the first instance of sensitive audio 122A; and the phrase “Can you please tell me when that charge will clear and . . . ” can correspond to the second instance of nonsensitive audio 124B. It should be understood that this example is illustrative, and therefore should not be construed as being limiting in any way.

FIG. 2 also illustrates an example of modified audio 202 that can be associated with the modified call 134. As shown in FIG. 2, the modified audio 202 can include a first instance of nonsensitive audio 124A, a first instance of substitute audio 138A, and a second instance of nonsensitive audio 124B. It can be appreciated that multiple instances of nonsensitive audio 124 and substitute audio 138 may be included, and that the illustrated example is merely illustrative and is provided for illustration purposes only. The first instance of nonsensitive audio 124A shown in the modified audio 202 can be similar or even identical to the first instance of nonsensitive audio 124A shown in the audio 200. Similarly, the second instance of nonsensitive audio 124B shown in the modified audio 202 can be similar or even identical to the second instance of nonsensitive audio 124B shown in the audio 200.

In the modified audio 202, however, the spoken words illustrated under the schematic representation of the modified call 134 can reflect what the agent and/or other entity at the agent device 120 hears. As can be appreciated with reference to FIG. 2, the phrase “1234 5678 9012 3456” has been removed or redacted from the modified audio 202 and replaced with the first instance of substitute audio 138A. Thus, the agent or other entity at the agent device 120 may not hear the credit card number. It should be understood that this example is illustrative, and therefore should not be construed as being limiting in any way.

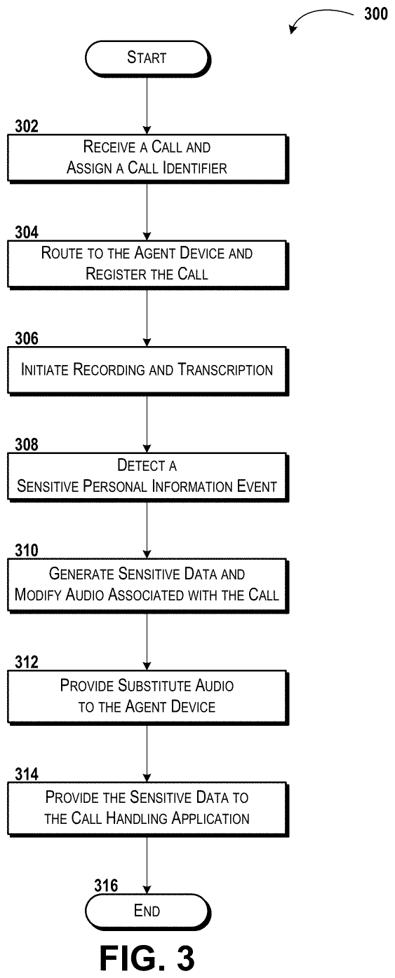

Turning now to FIG. 3, aspects of a method 300 for extracting and redacting sensitive information from audio will be described in detail, according to an illustrative embodiment. It should be understood that the operations of the method 300 disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device such as, for example, the computing device 106, the agent device 120, the application server 132, and/or other devices, to perform one or more operations and/or causing the processor to direct other components of the computing system or device to perform one or more of the operations.

For purposes of illustrating and describing the concepts of the present disclosure, the method 300 is described herein as being performed by the computing device 106 via execution of one or more software modules such as, for example, the extraction and redaction engine 110. It should be understood that additional and/or alternative devices and/or network nodes can provide the functionality described herein via execution of one or more modules, applications, and/or other software including, but not limited to, the extraction and redaction engine 110. Thus, the illustrated embodiments are illustrative, and should not be viewed as being limiting in any way.

The method 300 can begin at operation 302. At operation 302, the computing device 106 can receive a call 114 and can assign a call identifier 118 to the call 114. As explained above, the call 114 can be received with (and/or can be setup using) various types of data that can identify the calling party, a phone number associated with the calling party, an account associated with the calling party, and/or other personal information associated with the customer or other entity making the call 114. Thus, some embodiments of the concepts and technologies disclosed herein can be configured to remove any personal identifiers associated with the call 114 and assign the call identifier 118 to the call 114 for use by the agent device 120 (e.g., during call handling). In some other embodiments of the concepts and technologies disclosed herein, as noted above, the call identifier 118 can be assigned without removing the data that can identify the calling party. As such, it should be understood that these embodiments are illustrative and should not be construed as being limiting in any way.

It should be understood that in some embodiments, a customer's name, address, account number, and/or other information may be considered personal information and therefore may be removed from the call 114 (or data associated with the call 114) and/or may or may not be provided to the agent device 120 and/or some other entities. In some other embodiments, the customer's name, address, account number, ZIP code, passcode, and/or other information may not be considered personal information and therefore may not be removed from the call 114 (or data associated with the call 114) and/or may be provided to the agent device 120. These and other aspects of the extraction and redaction engine 110 and/or associated functionality as illustrated and described herein can be set by preferences, settings, and/or the like and therefore can vary among embodiments of the concepts and technologies disclosed herein and/or users of embodiments of the concepts and technologies disclosed herein. As such, the above example embodiment should be understood as being illustrative and should therefore not be construed as being limiting in any way.

From operation 302, the method 300 can proceed to operation 304. At operation 304, the computing device 106 can route the call 114 received in operation 302 to an agent device 120 and register the call 114. It can be appreciated that tens, hundreds, thousands, or even more agent devices 120 may exist. Thus, although not separately shown in FIG. 3, it can be appreciated that routing the call 114 to a particular agent device 120 can include putting the call 114 in a queue and/or other pool from which calls 114 can be routed to agent devices 120 and/or other functionality for identifying and/or determining a particular agent device 120 that is to handle the call 114.

After the call 114 has been received at a particular agent device 120, the computing device 106 can be configured to perform a call registration operation, during which the agent device 120 can receive the call 114 with a call identifier 118. As noted above, the call identifier 118 can be used as a substitute for some types of identifying information that may be associated with the call 114 and/or can be used for tracking purposes. Thus, the agent device 120 can, upon receiving the call 114 (or modified call 134 as shown in FIG. 1), confirm establishment of the call 114 (or modified call 134) and provide the call identifier 118 received with the call 114 (or modified call 134) to the computing device 106. It should be understood that this example is illustrative, and therefore should not be construed as being limiting in any way.

The computing device 106 can use the call identifier 118 to identify which call 114 has been routed to which agent device 120. This knowledge can be used by the computing device 106, for example, to determine which call 114 involves the exchange of sensitive personal information. Thus, the computing device 106 can identify, based on the call identifier 118, which agent device 120 is to receive substitute audio 138 and/or the modified call 134 (after removal of the sensitive information and/or sensitive audio 122 and/or without adding the sensitive information and/or sensitive audio 122 to the modified call 134 provided to the agent device 120). Because the registration of the call 114 can be performed for additional and/or alternative reasons, and because the tracking of the calls 114 can be accomplished using additional and/or alternative information and/or functionality, it should be understood that this example embodiment is illustrative of the concepts and technologies disclosed herein, and therefore should not be construed as being limiting in any way.

From operation 304, the method 300 can proceed to operation 306. At operation 306, the computing device 106 can initiate analysis of audio associated with the call 114. According to various embodiments, the computing device 106 can record the audio associated with the call 114, transcribe spoken words or other audio during the call 114, record and/or transcribe other data associated with the call 114 and/or other information associated with the call 114, combinations thereof, or the like. In various embodiments, the computing device 106 can use the speech recognition engine 108 to transcribe the call 114 and the extraction and redaction engine 110 to analyze output from the speech recognition engine 108 (e.g., text generated by a speech-to-text application, etc.). Thus, operation 306 can include the computing device 106 activating speech recognition functionality (e.g., the speech recognition engine 108) and speech analysis functionality (e.g., the extraction and redaction engine 110). It should be understood that this example is illustrative, and therefore should not be construed as being limiting in any way.

From operation 306, the method 300 can proceed to operation 308. At operation 308, the computing device 106 can detect a sensitive personal information event. As used herein, a “sensitive personal information event” can refer to the providing of, the speaking of, the entry of, and/or any other exchange of information that is potentially sensitive, commonly referred to as “sensitive personal information” in the telecommunications industry. Thus, in operation 308, the computing device 106 can determine that such an exchange of information is about to occur (before the actual exchange occurs as explained herein).

In some embodiments, as explained above with reference to FIG. 1, the computing device 106 can be configured to analyze language of spoken words in audio of the call 114 to detect an impending potential disclosure of sensitive personal information. In some other embodiments, computing device 106 can detect a sensitive personal information event by receiving or detecting an alert (e.g., the sensitive personal information event alert 126 illustrated and described in FIG. 1) or other event (e.g., selection of a “smart field” or other data entry field for input of sensitive personal information by an agent). A “smart field” as disclosed herein can correspond to a text entry field or other data entry functionality that, when selected by an agent or other entity, can generate a notification that sensitive personal information is about to be entered. In some embodiments, for example, selection of a smart field can cause the agent device 120 or other device to generate the sensitive personal information event alert 126. Because the impending disclosure of sensitive personal information can be detected in additional and/or alternative manners, it should be understood that these examples are illustrative, and therefore should not be construed as being limiting in any way.

Thus, it can be appreciated that the computing device 106 can perform the functionality of operation 308 by receiving an alert that indicates a sensitive personal information event (e.g., by receiving the sensitive personal information event alert 126), by detecting an impending or otherwise potential disclosure of sensitive personal information using speech recognition and/or analysis of speech recognition output, and/or by a combination of alerts and/or analysis. In one contemplated embodiment, the computing device 106 can receive a sensitive personal information event alert 126 or other notification and can, in response to receiving the sensitive personal information event alert 126 or other notification, the computing device 106 can initiate analysis of the speech recognition output to detect the impending disclosure of sensitive personal information. Because the sensitive personal information event can be detected in additional and/or alternative manners, it should be understood that the above examples of detecting the sensitive personal information event are illustrative, and therefore should not be construed as being limiting in any way.

From operation 308, the method 300 can proceed to operation 310. At operation 310, the computing device 106 can generate sensitive data 140 and can generate modified audio associated with the call 114. In particular, in some embodiments the computing device 106 can be configured to capture, at the computing device 106, the sensitive audio 122 associated with the call 114, redact the sensitive audio 122 from the call 114, and pass the call 114 including the nonsensitive audio 124 (and omitting the sensitive audio 122) to the agent device 120. In some embodiments, the computing device 106 can be configured to allow a modified version of the call 114 (e.g., the modified call 134) to be passed to the agent device 120, where the modified call 134 can include the nonsensitive audio 124 and substitute audio 138.

As discussed with reference to FIGS. 1-2, it can be appreciated that the modified call 134 can be similar or even identical to the call 114, though the modified call 134 can omit the sensitive audio 122 and/or can include the substitute audio 138, which can be substituted in some embodiments for the sensitive audio 122. Thus, in some embodiments, the computing device 106 can generate the modified call 134 in operation 310, where the modified call 134 can include the call identifier 118, the substitute audio 138 (a time period of soft tone, music, spoken words, or other audio that is substituted for a matching time period of sensitive audio 122 that has been removed), and other information such as, for example, characters, commands, and/or other information. It should be understood that this example is illustrative, and therefore should not be construed as being limiting in any way.

The computing device 106 also can be configured to generate sensitive data 140 as noted above. In particular, the computing device 106 can detect, in the sensitive audio 122, sensitive personal information. The computing device 106 can detect the sensitive personal information using speech recognition (e.g., as provided by the speech recognition engine 108) and analysis of a text associated with the call 114 (e.g., a text or transcription of the call 114 generated by speech recognition engine 108 or other functionality). The computing device 106 can generate the sensitive data 140 and store and/or transfer the sensitive data 140.

Thus, for example, if a customer says “my credit card number is one, two, three, four . . . five, six, seven, eight . . . nine, zero, one, two . . . three, four, five, six,” the computing device 106 can be configured to generate sensitive data 140 that can include or can represent the numeric string “1234 5678 9012 3456.” Although not illustrated in the FIGURES, it should be understood that the sensitive data 140 can be encrypted and/or otherwise protected before and/or during storage of the sensitive data 140, during or before transmission of the sensitive data 140 within the call center 102, and/or before and/or during transmission of the sensitive data 140 outside of the call center 102. It should be understood that this example is illustrative, and therefore should not be construed as being limiting in any way.

From operation 310, the method 300 can proceed to operation 312. At operation 312, the computing device 106 can provide the modified call 134 to the agent device 120. It can be appreciated that if the call 114 includes audio having fifteen seconds of nonsensitive audio 124, five seconds of sensitive audio 122, and another fifteen seconds of nonsensitive audio 124 (a total of thirty five seconds), that the modified call 134 provided to the agent device 120 can include fifteen seconds of nonsensitive audio 124, five seconds of substitute audio 138, and another fifteen seconds of nonsensitive audio 124 (a total of thirty five seconds).

Furthermore, in some embodiments the customer on the call 114 may be unaware that the agent cannot hear the customer, as substitute audio 138 or other audio (e.g., recorded key clicks, spoken words, ambient noise, etc.) may be provided as feedback to the customer (e.g., to simulate action being taken on the information by the agent and/or for other purposes). In some embodiments, the customer can hear the agent while saying or entering sensitive personal information, but the agent can hear the substitute audio 138 instead of the sensitive personal information. Because the substitute audio 138 can be audible to either or both parties, it should be understood that these examples are illustrative, and therefore should not be construed as being limiting in any way.

From operation 312, the method 300 can proceed to operation 314. At operation 314, the computing device 106 can provide the sensitive data 140 to the application server 132. In particular, the sensitive data 140 generated in operation 310 can be transmitted to the application server 132 by the computing device 106 and/or other devices and/or entities. In some embodiments, the computing device 106 can generate the sensitive data 140 such that the sensitive data 140 can include and/or can be accompanied by the call identifier 118. As noted above, the call identifier 118 can be included with and/or in the sensitive data 140 to enable the call handling application 130 to associate the sensitive data 140 with nonsensitive data 142 that can be provided by the agent device 120 to the call handling application 130 (also with the call identifier 118, in some embodiments). Because the sensitive data 140 and the nonsensitive data 142 can be correlated to one another in additional and/or alternative manners (e.g., without the call identifier 118), it should be understood that this example is illustrative, and therefore should not be construed as being limiting in any way.

From operation 314, the method 300 can proceed to operation 316. The method 300 can end at operation 316.

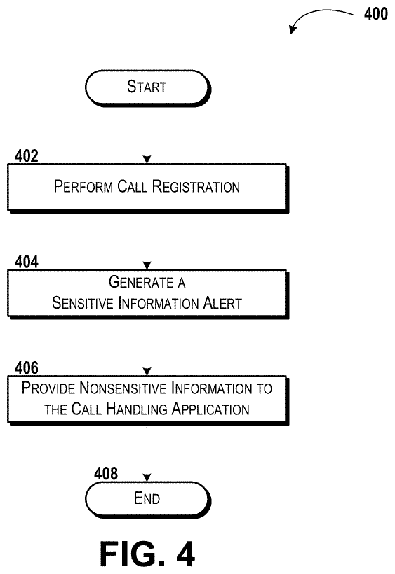

Turning now to FIG. 4, aspects of a method 400 for extracting and redacting sensitive information from audio will be described in detail, according to an illustrative embodiment. It should be understood that the operations of the method 400 disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

For purposes of illustrating and describing the concepts of the present disclosure, the method 400 is described herein as being performed by the agent device 120 via execution of one or more software modules such as, for example, the agent application 128. It should be understood that additional and/or alternative devices and/or network nodes can provide the functionality described herein via execution of one or more modules, applications, and/or other software including, but not limited to, the agent application 128. Thus, the illustrated embodiments are illustrative, and should not be viewed as being limiting in any way.

The method 400 can begin at operation 402. At operation 402, the agent device 120 can receive a call 114 and can perform a call registration process or operation. During call registration, as discussed above with reference to FIG. 2, the agent device 120 can communicate with the computing device 106 to communicate, to the computing device 106, a call identifier 118 that the agent device 120 received with the call 114. As explained above, the call identifier 118 can be used to enable the computing device 106 to associate audio of a call 114 with the agent device 120 that is handling that call 114, for association with data generated by the agent device 120 (e.g., the sensitive data 140), and/or for other purposes. Because call registration may be omitted in some embodiments, it should be understood that this example is illustrative, and therefore should not be construed as being limiting in any way. In some embodiments, for example, the computing device 106 can be configured to connect the call 114 to a specific agent device 120 and therefore can be aware of the identity of the agent device 120, which may be one of many contemplated manners in which the concepts and technologies disclosed herein can obviate the need for a registration process.

From operation 402, the method 400 can proceed to operation 404. At operation 404, the agent device 120 can generate a sensitive personal information event alert 126. As explained above, the sensitive personal information event alert 126 that is generated by the agent device 120 can indicate that sensitive personal information is about to be shared by a customer during the call 114. As explained above, the agent device 120 can detect the sensitive personal information event by detecting selection (e.g., by the agent) of a smart field or other field for entry of personal information (e.g., a credit card number, a name, a social security number, etc.), by detecting the agent asking for sensitive information (e.g., “what is your credit card number,” “what is your social security number,” or the like), and/or in other manners. Thus, operation 404 can correspond to the agent device 120 (e.g., via execution of the agent application 128), detecting the impending potential disclosure of sensitive personal information. As noted herein, the detection of a potential disclosure of sensitive personal information can occur at the computing device 106, in some embodiments, and therefore operation 404 can be omitted in some embodiments of the method 400 as noted above. As such, it should be understood that the illustrated example is illustrative, and therefore should not be construed as being limiting in any way.

From operation 404, the method 400 can proceed to operation 406. At operation 406, the agent device 120 can generate nonsensitive data 142 and/or can provide the nonsensitive data 142 to the call handling application 130. The nonsensitive data 142 can be generated by the agent device 120 (e.g., based on input and/or data provided to the agent device 120 with and/or outside of the modified call 134). For example, the nonsensitive data 142 can capture a service choice and/or parameter such as, for example, a number of minutes per month in a selected plan, a number of texts per month, a connection speed associated with an Internet plan, a data plan, a name, an address, combinations thereof, or the like. Because the nonsensitive data 142 can include any information and/or data that is not considered sensitive personal information, it should be understood that these examples of the nonsensitive data 142 are merely illustrative, and therefore should not be construed as being limiting in any way.

The agent device 120 can transmit (or cause other devices and/or entities to transmit) the nonsensitive data 142 to the application server 132. In some embodiments, the sensitive data 140 can include the call identifier 118 to enable the call handling application 130 to associate the nonsensitive data 142 provided by the agent device 120 to be associated with the sensitive data 140 that can be provided by the computing device 106. It should be understood that this example is illustrative, and therefore should not be construed as being limiting in any way.

From operation 406, the method 400 can proceed to operation 408. The method 400 can end at operation 408.

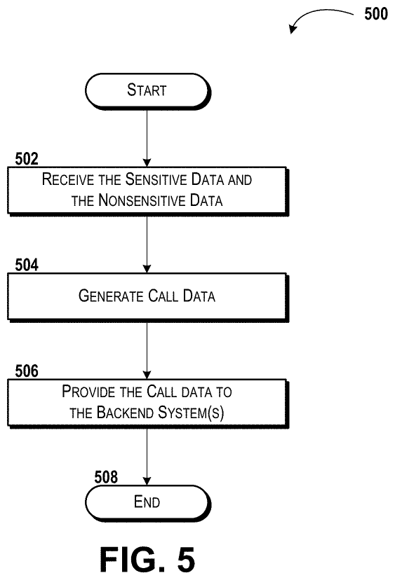

Turning now to FIG. 5, aspects of a method 500 for extracting and redacting sensitive information from audio will be described in detail, according to an illustrative embodiment. It should be understood that the operations of the method 500 disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

For purposes of illustrating and describing the concepts of the present disclosure, the method 500 is described herein as being performed by the application server 132 via execution of one or more software modules such as, for example, the call handling application 130. It should be understood that additional and/or alternative devices and/or network nodes can provide the functionality described herein via execution of one or more modules, applications, and/or other software including, but not limited to, the call handling application 130. Thus, the illustrated embodiments are illustrative, and should not be viewed as being limiting in any way.

The method 500 begins at operation 502. At operation 502, the application server 132 can receive sensitive data 140 and the nonsensitive data 142. According to various embodiments, the application server 132 can receive the sensitive data 140 from the computing device 106. According to various embodiments, the application server 132 can receive the nonsensitive data 142 from the agent device 120. As explained above, the application server 132 can receive, from the computing device 106 or other device, the sensitive data 140 with the call identifier 118, in some embodiments. Additionally, the application server 132 can receive, from the agent device 120 or other device, the nonsensitive data 142 with the call identifier 118, in some embodiments. Because the sensitive data 140 and the nonsensitive data 142 can be obtained from other devices and/or can be obtained without the call identifier 118 in some embodiments, it should be understood that this example is illustrative, and therefore should not be construed as being limiting in any way.

From operation 502, the method 500 can proceed to operation 504. At operation 504, the application server 132 can generate the call data 144. According to various embodiments, the call data 144 generated in operation 504 can include the sensitive data 140 and the nonsensitive data 142. The application server 132 can be configured to correlate the sensitive data 140 and the nonsensitive data 142 using the call identifier 118 or other keys or identifiers, in some embodiments. Thus, the call data 144 can include data that reflects the contents of the call 114, including the sensitive portions of the call 114 (e.g., sensitive personal information reflected in the sensitive audio 122 and the sensitive data 140 generated by the computing device 106) and the nonsensitive portions of the call 114 (e.g., the nonsensitive information reflected in the nonsensitive audio 124 of the call 114 and the nonsensitive data 142 generated by the agent device 120).

As such, the call data 144 can correspond, for example, to an order for a service and one or more service parameters associated with that service (nonsensitive information) and an account holder, payment account, and/or payment account information (sensitive personal information) associated with the order for the service. In some embodiments, the call data 144 can correspond to an order request, work order, or other command or instruction for completing an order or other service associated with the call 114. Because the call data 144 can include additional and/or alternative information as illustrated and described herein, it should be understood that this example is merely illustrative of the call data 144, and therefore should not be construed as being limiting in any way.

From operation 504, the method 500 can proceed to operation 506. At operation 506, the application server 132 can provide the call data 144 to one or more backend systems 146. In some embodiments, for example, the application server 132 can provide the call data 144 to one or more backend systems 146 such as one or more billing and/or charging entities for billing, charging, and/or other purposes. In some other embodiments, the application server 132 can additionally and/or alternatively provide the call data 144 to one or more backend systems 146 such as one or more provisioning modules for provisioning of a service and/or for making changes to a service.

In yet other embodiments, the application server 132 can additionally and/or alternatively provide the call data 144 to one or more backend systems 146 such as one or more engineering and/or operations entities for a service call and/or work order that relates to the call 114. It should be understood that the call data 144 can be provided to more than one backend system 146, and that the above examples of the backend systems 146 are merely illustrative of some contemplated backend systems 146 that may receive the call data 144. Thus, it should be understood that these examples are illustrative, and therefore should not be construed as being limiting in any way.

From operation 506, the method 500 can proceed to operation 508. The method 500 can end at operation 508.

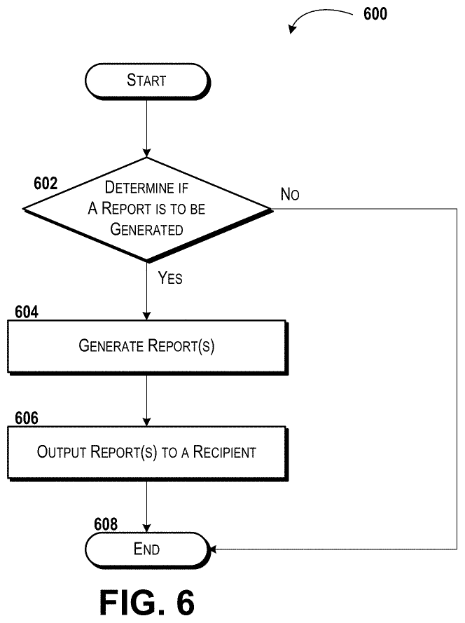

Turning now to FIG. 6, aspects of a method 600 for extracting and redacting sensitive information from audio will be described in detail, according to an illustrative embodiment. It should be understood that the operations of the method 600 disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

For purposes of illustrating and describing the concepts of the present disclosure, the method 600 is described herein as being performed by the computing device 106 via execution of one or more software modules such as, for example, the extraction and redaction engine 110. It should be understood that additional and/or alternative devices and/or network nodes can provide the functionality described herein via execution of one or more modules, applications, and/or other software including, but not limited to, the extraction and redaction engine 110. Thus, the illustrated embodiments are illustrative, and should not be viewed as being limiting in any way.

At operation 602, the computing device 106 can determine if a report 148 is to be generated. According to various embodiments of the concepts and technologies disclosed herein, the computing device 106 can determine that the report 148 is to be generated by receiving a request for the report 148. In some other embodiments, the computing device 106 can determine that the report 148 is to be generated based on expiration of a timer job. For example, in some embodiments a report 148 may be generated once a minute, once an hour, once a day, once a week, etc., and the timer job can, upon expiration, prompt the computing device 106 to generate a report 148.

In some other embodiments, the computing device 106 can determine that the report 148 is to be generated based a number of calls 114 handled by the computing device 106. For example, a report 148 may be generated after receiving, routing, and/or completing a call 114 or after a number of calls 114 such as five, ten, fifty, one hundred, one thousand, or other numbers of calls 114. Because the report 148 can be generated at any time and/or due to additional and/or alternative triggering events, requests, and/or other considerations, it should be understood that these examples are illustrative, and therefore should not be construed as being limiting in any way.

If the computing device 106 determines, in operation 602, that the report 148 is to be generated, the method 600 can proceed to operation 604. At operation 604, the computing device 106 can generate the report 148. The computing device 106 can generate the report 148 based on tracking calls 114 received by the computing device 106, a number of times and/or details relating to the functionality of the extraction and redaction engine 110 has been invoked and/or used; audio and/or information that has been removed from calls 114 (e.g., replaced with substitute audio 138, used to generate the sensitive data 140, combinations thereof, or the like); a number of override commands 152 received by the extraction and redaction engine 110; causes of override commands 152; and/or other details associated with the operation of the extraction and redaction engine 110. Because the report 148 can include these and/or other types of information, it should be understood that these example embodiments of contents of the report 148 are illustrative, and therefore should not be construed as being limiting in any way. One example embodiment of the report 148 will be illustrated and described with reference to FIG. 7C below, and will provide additional details about the information that can be included in some example embodiments of the report 148.

From operation 604, the method 600 can proceed to operation 606. At operation 606, the computing device 106 can output the report 148 generated in operation 604 to one or more recipients 150. The recipients 150 can use the report 148 for various purposes such as tracking use and/or performance of the extraction and redaction engine 110, making improvements to the extraction and redaction engine 110, tracking activity associated with agents using the extraction and redaction engine 110, troubleshooting and/or analyzing the extraction and redaction engine 110, combinations thereof, or the like. Because the reports 148 can be used for various purposes, it should be understood that these examples are illustrative, and therefore should not be construed as being limiting in any way.

From operation 606, the method 600 can proceed to operation 608. The method 600 also can proceed to operation 608 if the computing device 106 determines, in operation 602, that the report 148 is not to be generated. The method 600 can end at operation 608.

FIGS. 7A-7C are user interface (“UI”) diagrams showing aspects of UIs and/or UI elements for using and/or interacting with the speech recognition engine 108, the extraction and redaction engine 110, the agent application 128, and/or the call handling application 130, according to one illustrative embodiment of the concepts and technologies disclosed herein. FIG. 7A shows an illustrative screen display 700A. According to some embodiments of the concepts and technologies described herein, the screen display 700A can be generated by a device such as the agent device 120 via interactions with the extraction and redaction engine 110 and/or the agent application 128. Because the screen display 700A can be generated by other devices and/or other interactions with other applications and/or services, it should be understood that this example is illustrative, and therefore should not be construed as being limiting in any way.

In some embodiments, for example, the agent device 120 can generate the screen display 700A and/or other screen displays in conjunction with and/or based upon interactions with the agent application 128 described herein, which can be configured to render the screen display 700A. According to various embodiments, the screen display 700A can be presented, for example, when an agent or other user of the agent device 120 selects an option to enter a payment method for a customer (e.g., during a call 114). Because the screen display 700A illustrated in FIG. 7A can be displayed at additional and/or alternative times, it should be understood that these examples are illustrative and therefore should not be construed as being limiting in any way.

The screen display 700A can include various menus and/or menu options (not shown in FIG. 7A). The screen display 700A also can include a payment method entry window 702. The payment method entry window 702 can be configured to obtain payment method information from an agent (as provided by a customer during a call 114). As shown in FIG. 7A, the example embodiment of the payment method entry window 702 can include a payment type selector 704. The payment type selector 704 can include a drop-down menu or other functionality for selecting a payment type or method such as, for example, a credit card, a debit card, a bank account, or other payment type or method.

The payment method entry window 702 also can include a number of smart fields such as the smart field 706. As used herein, a “smart field” can, when selected at the agent device 120, cause the agent device 120 to generate and/or send a sensitive personal information event alert 126. As noted above, the generating and/or sending of the sensitive personal information event alert 126 can cause the computing device 106 to capture sensitive audio 122, to remove the sensitive audio 122 from the modified call 134, to add substitute audio 138 in the modified call 134 in place of the sensitive audio 122, and/or take other operations with regard to the sensitive personal information as illustrated and described herein. Thus, when the agent or other entity selects the smart field 706, the agent device 120 and/or the computing device 106 can be configured to perform operations that can result in the agent no longer being able to hear the customer. In some embodiments of the concepts and technologies disclosed herein, the agent may instead hear music, soft tones, and/or other audio instead as illustrated and described above at least until the customer has completed providing the sensitive personal information (or a substantial portion thereof).

In some embodiments of the concepts and technologies disclosed herein, the agent may be unable to hear the sensitive personal information in its entirety, while in some other embodiments the agent may be able to hear a portion of the sensitive personal information (e.g., the last four digits of a credit card number, social security number, or other number) to enable the agent to verify the last four digits, for example. Because the agent may be able to hear part of the sensitive personal information in some embodiments for additional and/or alternative reasons, it should be understood that this example is illustrative, and therefore should not be construed as being limiting in any way.

In the illustrated embodiment shown in FIG. 7A, the agent may select the smart field 706 and the agent device 120 can be configured to generate and/or send, in response to detecting selection of the smart field 706, the sensitive personal information event alert 126 to the computing device 106. The agent or a recorded message may ask the customer for his or her credit card number, for example, though other sensitive personal information may be obtained in a substantially similar manner. As the customer speaks the credit card number, ghost characters, masked characters, and/or other placeholder characters may be transmitted to the agent device 120 and/or the agent device 120 may otherwise be informed that characters associated with the smart field 706 have been obtained from the customer and/or other entity. It should be understood that this example is illustrative, and therefore should not be construed as being limiting in any way.

Thus, for example, asterisks or other characters may appear in the smart field 706 while the customer speaks numbers, though the agent or other entity may not hear the numbers and/or may be unable to see the numbers. Thus, the sensitive personal information (in this example a credit card number) may be protected from disclosure to the agent. Meanwhile, the extraction and redaction engine 110 can capture the spoken credit card number using a speech to text module or other functionality, generate sensitive data 140 that reflects the credit card number, and send the sensitive data 140 to the application server 132 as illustrated and described above. Thus, the payment method entry window 702 can provide feedback to the agent or other entity by filling the smart field 706 so the agent can track progress of the entry of the payment method, for example. It should be understood that this example is illustrative, and therefore should not be construed as being limiting in any way.

The payment method entry window 702 also can provide other types of feedback. In the illustrated embodiment, for example, a verification indicator 708 can indicate when the credit card information (or other data being obtained using the smart field 706) has been received and verified. In the example embodiment shown in FIG. 7A, the smart field 706 is illustrated as being colored green and having a green check mark for the verification indicator 708. The green color for the smart field 706 and the green check mark for the verification indicator 708 can indicate that the smart field 706 is filled with a correct number of characters and/or that the credit card number (or other information) in the smart field 706 has been verified. It should be understood that this example is illustrative, and therefore should not be construed as being limiting in any way.

As shown in FIG. 7A, the payment method entry window 702 also includes a text field 710 into which an expiration date can be entered (either by the agent or by the computing device 106 if the expiration date is considered sensitive personal information). In some embodiments, the text field 710 can be typed into by an agent, while in some other embodiments, the text field 710 can be configured as a smart field that, again, triggers the extraction and redaction engine 110 to obtain the expiration data (or other information) while masking or withholding the sensitive personal information and providing feedback to the agent device 120. It should be understood that this example is illustrative, and therefore should not be construed as being limiting in any way.

As shown in FIG. 7A, the payment method entry window 702 also includes a text field 712 into which a security code can be entered. In some embodiments, the text field 712 can be typed into by an agent, while in some other embodiments, the text field 712 can be configured as a smart field that, again, triggers the extraction and redaction engine 110 to obtain the security code for the credit card while masking or withholding the security code and while providing feedback to the agent device 120. It should be understood that this example is illustrative, and therefore should not be construed as being limiting in any way.

As shown in FIG. 7A, the payment method entry window 702 also includes a text field 714 into which a cardholder name can be entered. The text field 714 can be formatted as a regular text field or as a smart field that can trigger the extraction and redaction engine 110 to obtain the cardholder name for the credit card while masking or withholding the cardholder name and while providing feedback to the agent device 120. It should be understood that this example is illustrative, and therefore should not be construed as being limiting in any way.

The payment method entry window 702 also can include a UI control 716 to override functionality of the extraction and redaction engine 110, for example by causing the agent device 120 to generate the override command 152 illustrated and described above with reference to FIG. 1. Thus, selection of the UI control 716 can cause the agent device 120 to inform the computing device 106 that the extraction and redaction functionality of the extraction and redaction engine 110 is malfunctioning and/or otherwise can instruct the computing device 106 to deactivate the redaction and/or extraction of audio.

In some instances, for example, the agent may determine that the computing device 106 is removing nonsensitive audio 124 from the call 114, failing to properly obtain the payment information and/or other information from the customer, and/or otherwise not functionality properly. Thus, selection of the UI control 716 can cause the agent device 120 to perform operations that, when performed, can cause the computing device 106 to deactivate the extraction and redaction engine 110 and/or otherwise to allow the agent to hear the sensitive personal information for entry at the agent device 120. Thus, an agent may be enabled to enter the credit card information without interference in response to selecting the UI control 716. It should be understood that this example is illustrative, and therefore should not be construed as being limiting in any way.

According to various embodiments of the concepts and technologies disclosed herein, the UI control 716 can have an associated drop-down menu 718. The drop-down menu 718 can specify a reason for the requested the override of the extraction and redaction engine 110. In some embodiments, the drop-down menu 718 can include various reasons that may affect the accuracy of the extraction and redaction engine 110 such as, for example, that errors have been received, that audio quality is poor (which may result in the speech recognition engine 108 being unable to recognize spoken words and/or phrases), that the customer is upset and/or irate (which may result in the speech recognition engine 108 being unable to recognize spoken words and/or phrases), that the payment information seems inaccurate, that the system has failed, that the customer speaks an unsupported foreign language (which may result in the speech recognition engine 108 being unable to recognize spoken words and/or phrases), and/or other causes. Thus, the agent can select the cause for the override using the drop-down menu 718 and select the UI control 716 to send the request to override (e.g., the override command 152) with the specified reasons. It should be understood that this example is illustrative, and therefore should not be construed as being limiting in any way.

Although not shown in FIG. 7A, the payment method entry window 702 also can include a UI control to dismiss the payment method entry window 702. Thus, for example, the agent or other entity can select a UI control to cause the agent device 120 to close the payment method entry window 702. The payment method entry window 702 also can include a UI control for submitting the payment information (e.g., when the agent or other entity determines that the required fields are completed) and/or at other times. Because additional or alternative controls can be included in the payment method entry window 702, it should be understood that the example embodiment shown in FIG. 7A is illustrative and therefore should not be construed as being limiting in any way.

In the screen display 700B shown in FIG. 7B, it can be appreciated that in some embodiments, the smart field 706 can change colors and/or otherwise reflect that the credit card number (or other information) in the smart field 706 has not been (or cannot be) verified. As shown in FIG. 7B, an indicator 720 can provide a reason for the lack of validation. In the illustrated embodiment shown in FIG. 7B, the indicator 720 states that the credit card number (or other information) was not clearly understood. It should be understood that this example is illustrative, and therefore should not be construed as being limiting in any way.

Turning now to FIG. 7C, additional aspects of UIs and/or UI elements for using and/or interacting with the extraction and redaction engine 110 are shown, according to one illustrative embodiment of the concepts and technologies disclosed herein. FIG. 7C shows an illustrative screen display 700C. According to some embodiments of the concepts and technologies described herein, the screen display 700C can be generated by a device such as the computing device 106 and/or other devices in response to receiving a request for a report 148 and/or in response to determining a report 148 should be generated as illustrated and described herein. Because the report 148 can be generated at additional and/or alternative times, and because the report 148 may be generated in other formats and/or may not be rendered visually, it should be understood that this example is illustrative, and therefore should not be construed as being limiting in any way.

As shown in FIG. 7C, a report 148 can provide various statistics and/or other information relating to the extraction and redaction engine 110. In the illustrated embodiment, the example report 148 includes work center information, agent information, date information, and other information that can relate to the data reflected in the report 148. Thus, for example, a user or other entity can tailor a report 148 for specific dates and/or times, work centers, call centers 102, agents, etc. Thus, it should be understood that the illustrated example report 148 is illustrative, and therefore should not be construed as being limiting in any way.

The report 148 can include data for any number of work centers, agents, call centers 102, or the like. The report 148 also can include data that reflects a total number of calls 114 handled by one or more agents or work centers, a total number of overrides of the extraction and redaction engine 110 by one or more agents or work centers, a percentage of overrides of the extraction and redaction engine 110 by one or more agents or work centers (as a percentage of override opportunities), a percentage of overrides of the extraction and redaction engine 110 by one or more agents or work centers (as a percentage of total calls 114), a total number of calls 114 handled by one or more agents or work centers that involved the obtaining of credit card information, a total number of overrides of the extraction and redaction engine 110 by one or more agents or work centers during credit card calls 114 (calls 114 in which credit card information was obtained), a total number of non-credit card calls 114 (calls 114 in which no credit card information was obtained) by one or more agents or work centers, a total number of overrides of the extraction and redaction engine 110 by one or more agents or work centers during the non-credit card calls 114, and various reasons for overrides as entered by one or more agents or work centers (e.g., using the drop-down menu 718 as described in FIG. 7A) such as, for example, multiple reasons, audio quality, irate customers, payment research, system not responding, and/or language issues. Because other data can be included in a report 148, it should be understood that this example is illustrative, and therefore should not be construed as being limiting in any way.

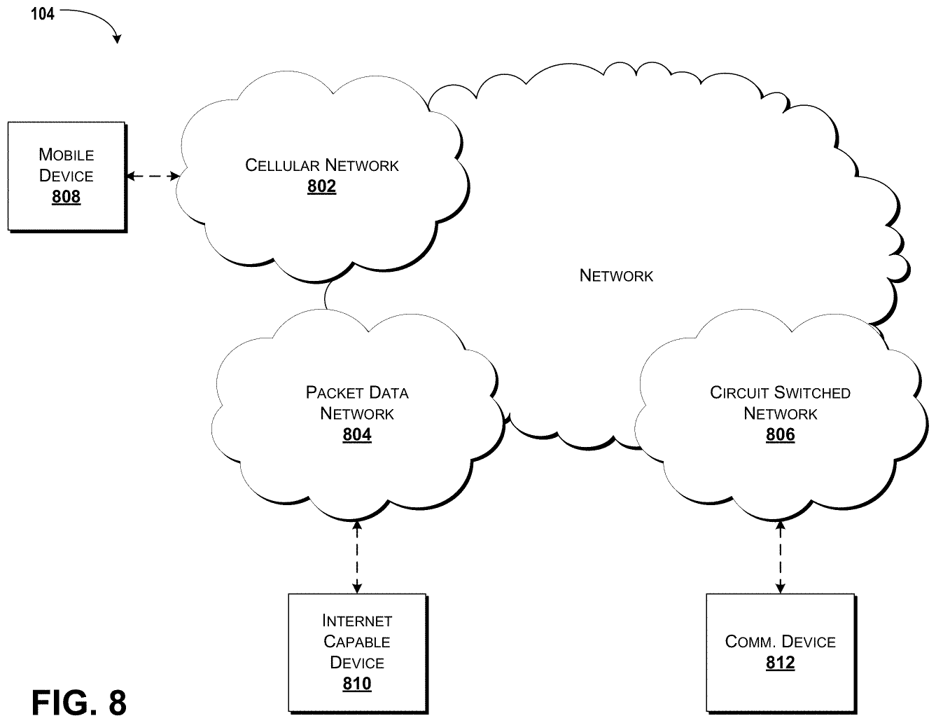

Turning now to FIG. 8, additional details of the network 104 are illustrated, according to an illustrative embodiment. The network 104 includes a cellular network 802, a packet data network 804, for example, the Internet, and a circuit switched network 806, for example, a publicly switched telephone network (“PSTN”). The cellular network 802 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 802 also includes radios and nodes for receiving and transmitting voice, data, and combinations thereof to and from radio transceivers, networks, the packet data network 804, and the circuit switched network 806.

A mobile communications device 808, such as, for example, a cellular telephone, a user equipment, a mobile terminal, a PDA, a laptop computer, a handheld computer, and combinations thereof, can be operatively connected to the cellular network 802. The cellular network 802 can be configured as a 2G GSM network and can provide data communications via GPRS and/or EDGE. Additionally, or alternatively, the cellular network 802 can be configured as a 3G UMTS network and can provide data communications via the HSPA protocol family, for example, HSDPA, EUL (also referred to as HSDPA), and HSPA+. The cellular network 802 also is compatible with 4G mobile communications standards as well as evolved and future mobile standards.

The packet data network 804 includes various devices, for example, servers, computers, databases, and other devices in communication with one another, as is generally known. The packet data network 804 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 804 includes or is in communication with the Internet. The circuit switched network 806 includes various hardware and software for providing circuit switched communications. The circuit switched network 806 may include, or may be, what is often referred to as a plain old telephone system (POTS). The functionality of a circuit switched network 806 or other circuit-switched network are generally known and will not be described herein in detail.

The illustrated cellular network 802 is shown in communication with the packet data network 804 and a circuit switched network 806, though it should be appreciated that this is not necessarily the case. One or more Internet-capable devices 810, for example, a PC, a laptop, a portable device, or another suitable device, can communicate with one or more cellular networks 802, and devices connected thereto, through the packet data network 804. It also should be appreciated that the Internet-capable device 810 can communicate with the packet data network 804 through the circuit switched network 806, the cellular network 802, and/or via other networks (not illustrated).

As illustrated, a communications device 812, for example, a telephone, facsimile machine, modem, computer, or the like, can be in communication with the circuit switched network 806, and therethrough to the packet data network 804 and/or the cellular network 802. It should be appreciated that the communications device 812 can be an Internet-capable device, and can be substantially similar to the Internet-capable device 810. In the specification, the network 104 is used to refer broadly to any combination of the networks 802, 804, 806. It should be appreciated that substantially all of the functionality described with reference to the network 104 can be performed by the cellular network 802, the packet data network 804, and/or the circuit switched network 806, alone or in combination with other networks, network elements, and the like.

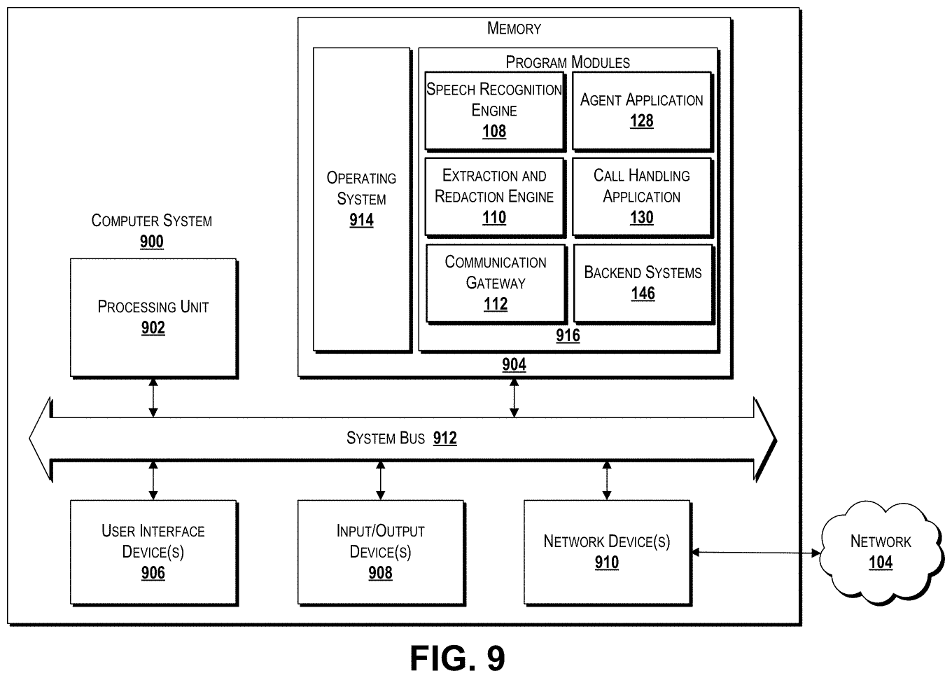

FIG. 9 is a block diagram illustrating a computer system 900 configured to provide the functionality described herein for extracting and redacting sensitive information from audio, in accordance with various embodiments of the concepts and technologies disclosed herein. The computer system 900 includes a processing unit 902, a memory 904, one or more user interface devices 906, one or more input/output (“I/O”) devices 908, and one or more network devices 910, each of which is operatively connected to a system bus 912. The bus 912 enables bi-directional communication between the processing unit 902, the memory 904, the user interface devices 906, the I/O devices 908, and the network devices 910.

The processing unit 902 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 904 communicates with the processing unit 902 via the system bus 912. In some embodiments, the memory 904 is operatively connected to a memory controller (not shown) that enables communication with the processing unit 902 via the system bus 912. The memory 904 includes an operating system 914 and one or more program modules 916. The operating system 914 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 916 may include various software and/or program modules described herein. In some embodiments, for example, the program modules 916 include the communication gateway 112, the speech recognition engine 108, the extraction and redaction engine 110, the agent application 128, and/or the call handling application 130. These and/or other programs can be embodied in computer-readable media containing instructions that, when executed by the processing unit 902, perform one or more of the methods 300, 400, 500, and 600 described in detail above with respect to FIGS. 3-6 and/or other functionality as illustrated and described herein.

It can be appreciated that, at least by virtue of the instructions embodying the methods 300, 400, 500, and 600, and/or other functionality illustrated and described herein being stored in the memory 904 and/or accessed and/or executed by the processing unit 902, the computer system 900 is a special-purpose computing system that can facilitate providing the functionality illustrated and described herein. According to embodiments, the program modules 916 may be embodied in hardware, software, firmware, or any combination thereof. Although not shown in FIG. 9, it should be understood that the memory 904 also can be configured to store the call identifier 118, the sensitive audio 122, the nonsensitive audio 124, the sensitive personal information event alert 126, the substitute audio 138, the sensitive data 140, the nonsensitive data 142, the call data 144, the report 148, the override command 152, and/or other data, if desired.

By way of example, and not limitation, computer-readable media may include any available computer storage media or communication media that can be accessed by the computer system 900. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 900. In the claims, the phrase “computer storage medium” and variations thereof does not include waves or signals per se and/or communication media.

The user interface devices 906 may include one or more devices with which a user accesses the computer system 900. The user interface devices 906 may include, but are not limited to, computers, servers, personal digital assistants, cellular phones, or any suitable computing devices. The I/O devices 908 enable a user to interface with the program modules 916. In one embodiment, the I/O devices 908 are operatively connected to an I/O controller (not shown) that enables communication with the processing unit 902 via the system bus 912. The I/O devices 908 may include one or more input devices, such as, but not limited to, a keyboard, a mouse, or an electronic stylus. Further, the I/O devices 908 may include one or more output devices, such as, but not limited to, a display screen or a printer.

The network devices 910 enable the computer system 900 to communicate with other networks or remote systems via a network, such as the network 104. Examples of the network devices 910 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

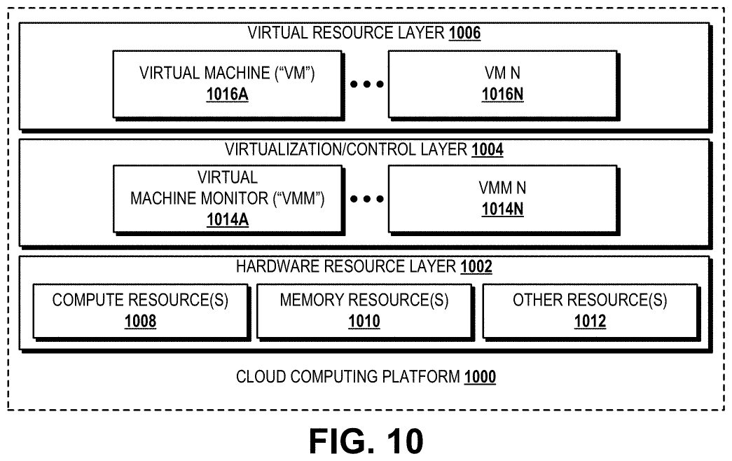

FIG. 10 illustrates an illustrative architecture for a cloud computing platform 1000 that can be capable of executing the software components described herein for extracting and redacting sensitive information from audio and/or for interacting with the communication gateway 112, the speech recognition engine 108, the extraction and redaction engine 110, the agent application 128, and/or the call handling application 130. Thus, it can be appreciated that in some embodiments of the concepts and technologies disclosed herein, the cloud computing platform 1000 illustrated in FIG. 10 can be used to provide the functionality described herein with respect to the computing device 106, the communication gateway 112, the customer device 116, the agent device 120, the application server 132, the backend systems 146, and/or the recipient 150.

The cloud computing platform 1000 thus may be utilized to execute any aspects of the software components presented herein. Thus, according to various embodiments of the concepts and technologies disclosed herein, the communication gateway 112, the speech recognition engine 108, the extraction and redaction engine 110, the agent application 128, and/or the call handling application 130 can be implemented, at least in part, on or by elements included in the cloud computing platform 1000 illustrated and described herein. Those skilled in the art will appreciate that the illustrated embodiment of the cloud computing platform 1000 is a simplification of but only one possible implementation of an illustrative cloud computing platform, and as such, the illustrated cloud computing platform 1000 should not be construed as being limiting in any way.

In the illustrated embodiment, the cloud computing platform 1000 can include a hardware resource layer 1002, a virtualization/control layer 1004, and a virtual resource layer 1006. These layers and/or other layers can be configured to cooperate with each other and/or other elements of a cloud computing platform 1000 to perform operations as will be described in detail herein. While connections are shown between some of the components illustrated in FIG. 10, it should be understood that some, none, or all of the components illustrated in FIG. 10 can be configured to interact with one another to carry out various functions described herein. In some embodiments, the components are arranged so as to communicate via one or more networks such as, for example, the network 104 illustrated and described hereinabove (not shown in FIG. 10). Thus, it should be understood that FIG. 10 and the following description are intended to provide a general understanding of a suitable environment in which various aspects of embodiments can be implemented, and should not be construed as being limiting in any way.

The hardware resource layer 1002 can provide hardware resources. In the illustrated embodiment, the hardware resources can include one or more compute resources 1008, one or more memory resources 1010, and one or more other resources 1012. The compute resource(s) 1006 can include one or more hardware components that can perform computations to process data, and/or to execute computer-executable instructions of one or more application programs, operating systems, services, and/or other software including, but not limited to, the communication gateway 112, the speech recognition engine 108, the extraction and redaction engine 110, the agent application 128, and/or the call handling application 130 illustrated and described herein.

According to various embodiments, the compute resources 1008 can include one or more central processing units (“CPUs”). The CPUs can be configured with one or more processing cores. In some embodiments, the compute resources 1008 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 1008 can include one or more discrete GPUs. In some other embodiments, the compute resources 1008 can include one or more CPU and/or GPU components that can be configured in accordance with a co-processing CPU/GPU computing model. Thus, it can be appreciated that in some embodiments of the compute resources 1008, a sequential part of an application can execute on a CPU and a computationally-intensive part of the application can be accelerated by the GPU. It should be understood that this example is illustrative, and therefore should not be construed as being limiting in any way.

In some embodiments, the compute resources 1008 also can include one or more system on a chip (“SoC”) components. It should be understood that the SoC component can operate in association with one or more other components as illustrated and described herein, for example, one or more of the memory resources 1010 and/or one or more of the other resources 1012. In some embodiments in which an SoC component is included, the compute resources 1008 can be or can include one or more embodiments of the SNAPDRAGON brand family of SoCs, available from QUALCOMM of San Diego, Calif.; one or more embodiment of the TEGRA brand family of SoCs, available from NVIDIA of Santa Clara, Calif.; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Tex.; one or more customized versions of any of the above SoCs; and/or one or more other brand and/or one or more proprietary SoCs.

The compute resources 1008 can be or can include one or more hardware components arranged in accordance with an ARM architecture, available for license from ARM HOLDINGS of Cambridge, United Kingdom. Alternatively, the compute resources 1008 can be or can include one or more hardware components arranged in accordance with an x86 architecture, such as an architecture available from INTEL CORPORATION of Mountain View, Calif., and others. Those skilled in the art will appreciate the implementation of the compute resources 1008 can utilize various computation architectures and/or processing architectures. As such, the various example embodiments of the compute resources 1008 as mentioned hereinabove should not be construed as being limiting in any way. Rather, implementations of embodiments of the concepts and technologies disclosed herein can be implemented using compute resources 1008 having any of the particular computation architecture and/or combination of computation architectures mentioned herein as well as other architectures.

Although not separately illustrated in FIG. 10, it should be understood that the compute resources 1008 illustrated and described herein can host and/or execute various services, applications, portals, and/or other functionality illustrated and described herein. Thus, the compute resources 1008 can host and/or can execute the communication gateway 112, the speech recognition engine 108, the extraction and redaction engine 110, the agent application 128, the call handling application 130, and/or other applications or services illustrated and described herein.

The memory resource(s) 1010 can include one or more hardware components that can perform or provide storage operations, including temporary and/or permanent storage operations. In some embodiments, the memory resource(s) 1010 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 1008, subject to the definition of “computer storage media” provided above (e.g., as excluding waves and signals per se and/or communication media as defined in this application).

Although not illustrated in FIG. 10, it should be understood that the memory resources 1010 can host or store the various data illustrated and described herein including, but not limited to, the call identifier 118, the sensitive audio 122, the nonsensitive audio 124, the sensitive personal information event alert 126, the substitute audio 138, the sensitive data 140, the nonsensitive data 142, the call data 144, the report 148, the override command 152, and/or other data, if desired. It should be understood that this example is illustrative, and therefore should not be construed as being limiting in any way.

The other resource(s) 1012 can include any other hardware resources that can be utilized by the compute resources(s) 1006 and/or the memory resource(s) 1010 to perform operations. The other resource(s) 1012 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 1002 can be virtualized by one or more virtual machine monitors (“VMMs”) 1014A-1014N (also known as “hypervisors;” hereinafter “VMMs 1014”). The VMMs 1014 can operate within the virtualization/control layer 1004 to manage one or more virtual resources that can reside in the virtual resource layer 1006. The VMMs 1014 can be or can include software, firmware, and/or hardware that alone or in combination with other software, firmware, and/or hardware, can manage one or more virtual resources operating within the virtual resource layer 1006.

The virtual resources operating within the virtual resource layer 1006 can include abstractions of at least a portion of the compute resources 1008, the memory resources 1010, the other resources 1012, or any combination thereof. These abstractions are referred to herein as virtual machines (“VMs”). In the illustrated embodiment, the virtual resource layer 1006 includes VMs 1016A-1016N (hereinafter “VMs 1016”).

Based on the foregoing, it should be appreciated that systems and methods for extracting and redacting sensitive information from audio have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
receiving a call associated with a customer,
routing the call to an agent device,
detecting, during the call, an impending disclosure of sensitive personal information of the customer,
generating sensitive data that corresponds to the sensitive personal information, wherein the sensitive data is generated based on sensitive audio of the call,
providing modified audio to the agent device, wherein the modified audio includes nonsensitive audio of the call, and wherein the modified audio omits the sensitive audio, and
providing the sensitive data to a call handling application that is in communication with the agent device.

2. The system of claim 1, wherein detecting the impending disclosure of the sensitive personal information of the customer comprises receiving, from the agent device, a sensitive personal information event alert, wherein the sensitive personal information event alert indicates that the sensitive personal information is about to be disclosed.

3. The system of claim 2, wherein the agent device generates the sensitive personal information event alert in response to detecting a selection, at the agent device, of a field for entry of the sensitive personal information.

4. The system of claim 1, wherein the modified audio includes substitute audio that replaces the sensitive audio in real-time, whereby the sensitive audio is not provided to the agent device, and whereby the nonsensitive audio and the substitute audio are provided to the agent device.

5. The system of claim 1, wherein detecting the impending disclosure of the sensitive personal information of the customer comprises:
performing, on call audio associated with the call, speech recognition to transcribe spoken words associated with the call; and
detecting, via analysis of the spoken words, the impending disclosure of the sensitive personal information.

6. A method comprising:
receiving, at a computing device comprising a processor, a call associated with a customer;
routing, by the computing device, the call to an agent device;
detecting, by the computing device and during the call, an impending disclosure of sensitive personal information of the customer;
generating, by the computing device, sensitive data that corresponds to the sensitive personal information, wherein the sensitive data is generated based on sensitive audio of the call;
providing, by the computing device, modified audio to the agent device, wherein the modified audio includes nonsensitive audio of the call, and wherein the modified audio omits the sensitive audio; and
providing, by the computing device, the sensitive data to a call handling application that is in communication with the computing device and with the agent device.

7. The method of claim 6, wherein detecting the impending disclosure of the sensitive personal information of the customer comprises receiving, from the agent device, a sensitive personal information event alert.

8. The method of claim 7, wherein the agent device generates the sensitive personal information event alert in response to detecting a selection, at the agent device, of a field for entry of the sensitive personal information.

9. The method of claim 7, wherein the sensitive personal information event alert indicates that the sensitive personal information is about to be disclosed.

10. The method of claim 6, further comprising:
assigning, to the call, a call identifier, wherein the agent device registers the call with the computing device using the call identifier, and wherein the call identifier is used to route audio associated with the call to the agent device.

11. The method of claim 10, further comprising:
providing, by the computing device, the call identifier to the call handling application, wherein the call identifier is included in the sensitive data, and wherein the call handling application uses the call identifier to correlate the sensitive data to nonsensitive data obtained from the agent device.

12. The method of claim 6, wherein the modified audio includes substitute audio that replaces the sensitive audio, whereby the sensitive audio is not provided to the agent device, and whereby the nonsensitive audio and the substitute audio are provided to the agent device.

13. The method of claim 6, further comprising:
removing, from the call, identifying information associated with the customer; and
assigning, to the call, a call identifier, wherein the agent device registers the call with the computing device using the call identifier.

14. The method of claim 6, wherein detecting the impending disclosure of the sensitive personal information of the customer comprises:
performing, on call audio associated with the call, speech recognition to transcribe spoken words associated with the call; and
detecting, via analysis of the spoken words, the impending disclosure of the sensitive personal information.

15. The method of claim 6, further comprising:
generating, by the computing device, a report, wherein the report indicates a number of calls received at the computing device, the calls comprising the call; a number of times among the calls that sensitive information has been shared during the calls; and a number of times that removal of the sensitive information has been overridden by agent devices comprising the agent device.

16. A computer storage medium having computer-executable instructions stored thereon that, when executed by a processor, cause the processor to perform operations comprising:
receiving a call associated with a customer;
routing the call to an agent device;
detecting, during the call, an impending disclosure of sensitive personal information of the customer;
generating sensitive data that corresponds to the sensitive personal information, wherein the sensitive data is generated based on sensitive audio of the call;
providing modified audio to the agent device, wherein the modified audio includes nonsensitive audio of the call, and wherein the modified audio omits the sensitive audio; and
providing the sensitive data to a call handling application that is in communication with the agent device.

17. The computer storage medium of claim 16, wherein detecting the impending disclosure of the sensitive personal information of the customer comprises receiving, from the agent device, a sensitive personal information event alert, wherein the sensitive personal information event alert indicates that the sensitive personal information is about to be disclosed.

18. The computer storage medium of claim 17, wherein the agent device generates the sensitive personal information event alert in response to detecting a selection, at the agent device, of a field for entry of the sensitive personal information.

19. The computer storage medium of claim 16, wherein the modified audio includes substitute audio that replaces the sensitive audio, whereby the sensitive audio is not provided to the agent device, and whereby the nonsensitive audio and the substitute audio are provided to the agent device.

20. The computer storage medium of claim 16, wherein detecting the impending disclosure of the sensitive personal information of the customer comprises:
performing, on call audio associated with the call, speech recognition to transcribe spoken words associated with the call; and
detecting, via analysis of the spoken words, the impending disclosure of the sensitive personal information.
